(19) United States
(12) Patent Application Publication
(10) Pub. No.: US 2017/0373342 A1
(43) Pub. Date: Dec. 28, 2017

(54) BATTERY WITH MOLYBDENUM SULFIDE ELECTRODE AND METHODS

(71) Applicant: The Regents of the University of California, Oakland, CA (US)

(72) Inventors: Juchen Guo, Anaheim, CA (US); Linxiao Geng, Riverside, CA (US)

(21) Appl. No.: 15/469,159

(22) Filed: Mar. 24, 2017

Related U.S. Application Data
(60) Provisional application No. 62/355,699, filed on Jun. 28, 2016.

(51) Int. Cl. H01M 10/054; H01M 4/58; H01M 4/38; H01M 10/0564; H01M 10/0568; H01M 10/0569

(52) U.S. Cl. CPC H01M 10/054; H01M 10/0568; H01M 10/0569; H01M 4/38; H01M 10/0564; H01M 4/5815; H01M 2300/0025

(57) ABSTRACT

A battery having a metal sulfide electrode, and an aluminum containing electrolyte and methods are shown. In one example, the electrolyte includes one or more organic salts. In one example, the metal sulfide includes molybdenum sulfide. In one example, the metal sulfide includes titanium sulfide.

### RELATED APPLICATION

This application claims priority to U.S. Provisional Patent Application No. 62/355,699, entitled “RECHARGEABLE BATTERY WITH ALUMINUM NEGATIVE ELECTRODE AND CHERVEL PHASE MOLYBDENUM SULFIDE POSITIVE ELECTRODE,” filed on Jun. 28, 2016, which is incorporated herein by reference in its entirety.

### TECHNICAL FIELD

This invention relates to batteries.

### BACKGROUND

Improved batteries are desired. One example of a battery structure that can be improved is an electrode and electrolyte structure and material choice.

### BRIEF DESCRIPTION OF THE DRAWINGS

FIGS. 1A-1B show SEM images and XRD data of a metal sulfide material according to an example of the invention.

FIGS. 2A-2D show electrochemical data of a metal sulfide battery according to an example of the invention.

FIGS. 3A-3D show characterization data of a metal sulfide material according to an example of the invention.

FIGS. 4A-4B show additional characterization data of a metal sulfide material according to an example of the invention.

FIGS. 5A-5C show electrochemical data of a metal sulfide battery according to an example of the invention.

FIG. 6 shows images of a metal sulfide material according to an example of the invention.

FIGS. 7A-7F show electrochemical data of a metal sulfide battery according to an example of the invention.

FIG. 8 shows chemical analysis data of a metal sulfide material according to an example of the invention.

FIGS. 9A-9C show a crystallographic model of a metal sulfide material according to an example of the invention.

FIGS. 10A-10B show electrochemical data of a metal sulfide battery according to an example of the invention.

FIG. 11 shows surface area data of a metal sulfide material according to an example of the invention.

FIGS. 12A-12D show characterization data of a metal sulfide material according to an example of the invention.

FIGS. 13A-13C show additional characterization data of a metal sulfide material according to an example of the invention.

FIGS. 14A-14B show electrochemical data of a metal sulfide battery according to an example of the invention.

FIGS. 15A-15D show additional electrochemical data of a metal sulfide battery according to an example of the invention.

FIGS. 16A-16B show additional electrochemical data of a metal sulfide battery according to an example of the invention.

FIGS. 17A-17D show additional electrochemical data of a metal sulfide battery according to an example of the invention.

FIG. 18 shows a battery according to an example of the invention.

### DETAILED DESCRIPTION

In the following detailed description, reference is made to the accompanying drawings which form a part hereof, and in which is shown, by way of illustration, specific embodiments in which the invention may be practiced. In the drawings, like numerals describe substantially similar components throughout the several views. These embodiments are described in sufficient detail to enable those skilled in the art to practice the invention. Other embodiments may be utilized and structural, or logical changes, etc. may be made without departing from the scope of the present invention.

Among the rechargeable batteries beyond lithium chemistry, the ones based on aluminum (Al) are particularly promising: Al not only is the most abundant metal in the earth's crust but also has attractive capacity due to its trivalency. To date, there were only scarce investigations on rechargeable Al batteries in literature. The initial investigations, as summarized in the review article by Li and Bjerrum, were focused on identifying Al-ion electrolytes from organic solvents and demonstrating potential cathode materials. However, these early attempts had little success due to the sluggish electrochemical Al deposition-dissolution in organic solvents. On the other hand, reversible electrochemical Al deposition-dissolution can be facilely achieved in ionic liquid (ILs) electrolytes composed of aluminum chloride (AlCl₃) and organic salts such as 1-butylpyridinium chloride, 1-ethyl-3-methylimidazolium chloride, and 1-butyl-3-methylimidazolium chloride ([BMIm]Cl). Utilizing IL electrolytes, aluminum-chlorine (Al—Cl2) rechargeable batteries were demonstrated. Despite the high discharge voltage (>1.5 V), good capacity, and cycle stability, the gaseous Cl₂ cathode was problematic. Furthermore, the Cl₂ cathode had to be first generated from the electrolysis of electrolyte through charging, which was also undesirable. More recently, vanadium oxide fluorinated graphite, chloroaluminate-doped conductive polymers, and graphitic carbons were also reported as cathode materials vs Al in the IL-based electrolytes.

Unlike lithium, electrochemical Al intercalation into a host crystal structure can be very difficult due to the strong Coulombic effect induced by the three positive charges carried by the Al cation. Therefore, transition metal oxides, i.e., oxide anionic frameworks, may not be the ideal hosts for Al because of their strong electrostatic attraction with Al cations. It can hinder the redistribution of the charge of Al cations in the crystal, thus preventing the Al intercalation. On the other hand, sulfur has lower electronegativity than oxygen and is more polarizable due to its larger atom radius. Therefore, the charge redistribution in the sulfide anionic frameworks should be superior to oxides. Based on this concept, we demonstrate in this study the reversible electrochemical Al intercalation in Chevrel phase molybdenum sulfide (Mo₆S₈) for the first time.

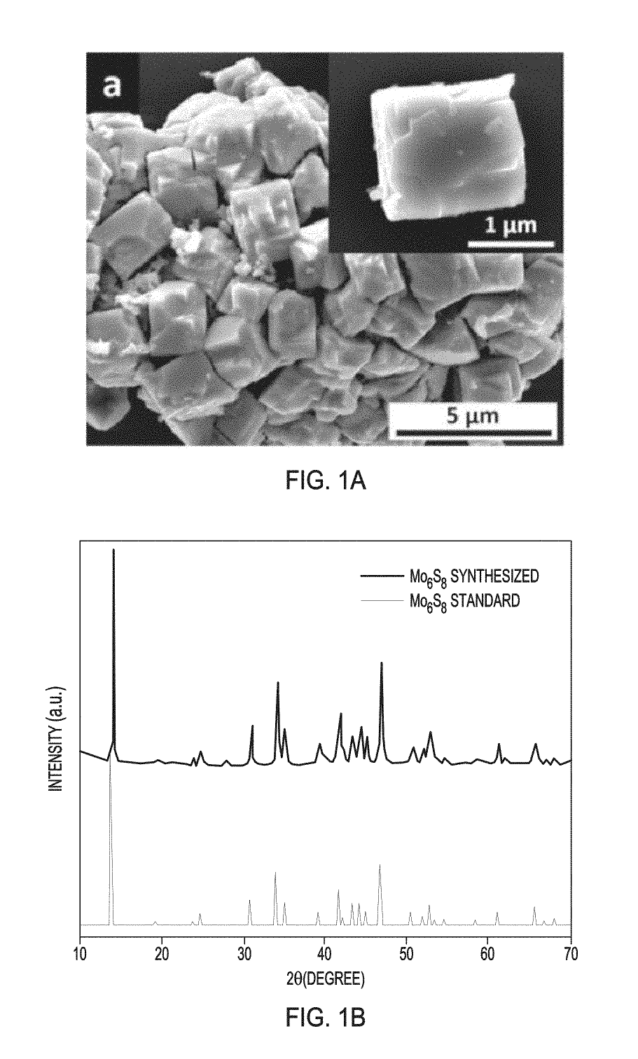

Mo₆S₈ has a unique crystal structure of stacked Mo₆S₈ blocks composed of an octahedral cluster of Mo atoms inside a sulfur anion cubic cell. It is known to have two types of sites between the sulfur cubes that are capable to accommodate small cations such as Li+, Cu+, and Mg2+.14,15 Aurbach and co-workers first demonstrated Mo₆S₈ as a cathode material for rechargeable magnesium-ion batteries.16 In this study, we synthesized Mo₆S₈ particles through a precipitation method modified from the reported works by Kumta et al, and Liu et al. As shown in the scanning electron microscopy (SEM) image in FIG. 1A, the particle shape is cubic and the typical particle size is within the range of 1-2 μm. FIG. 1B shows the X-ray powder diffraction (XRD) pattern, which is in excellent agreement with the pure Mo₆S₈ standard without the typical impurity of MoS₂.

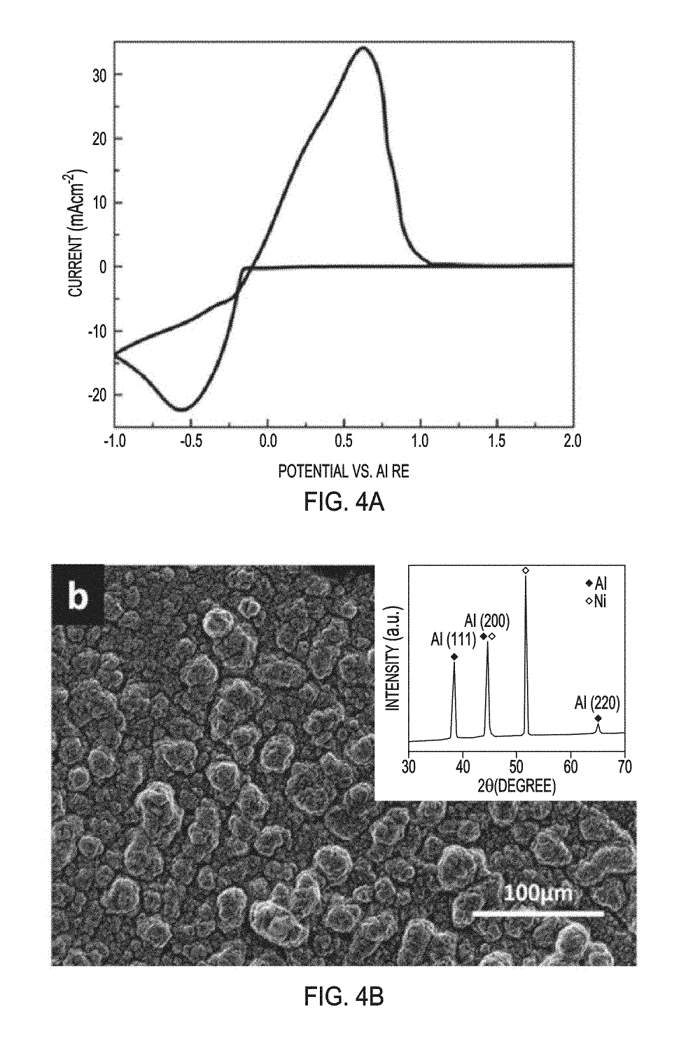

The electrochemical Al intercalation in Mo₆S₈ was analyzed in CR2016 coin cells with Al foil as the counter/reference electrode. An IL electrolyte composed of a mixture of AlCl₃ and [BMIm]Cl with a molar ratio of 1.5:1 was used, it has been demonstrated that reversible Al deposition-dissolution can only be achieved in a Lewis acidic electrolyte composed of AlCl₃ and an IL with molar ratio >1, and the electroactive species in the electrolyte is [Al₂Cl₇]-anion. Indeed, facile Al deposition-dissolution was enabled by the prepared AlCl3-[BMIm]Cl electrolyte as shown in FIGS. 4A-4B.

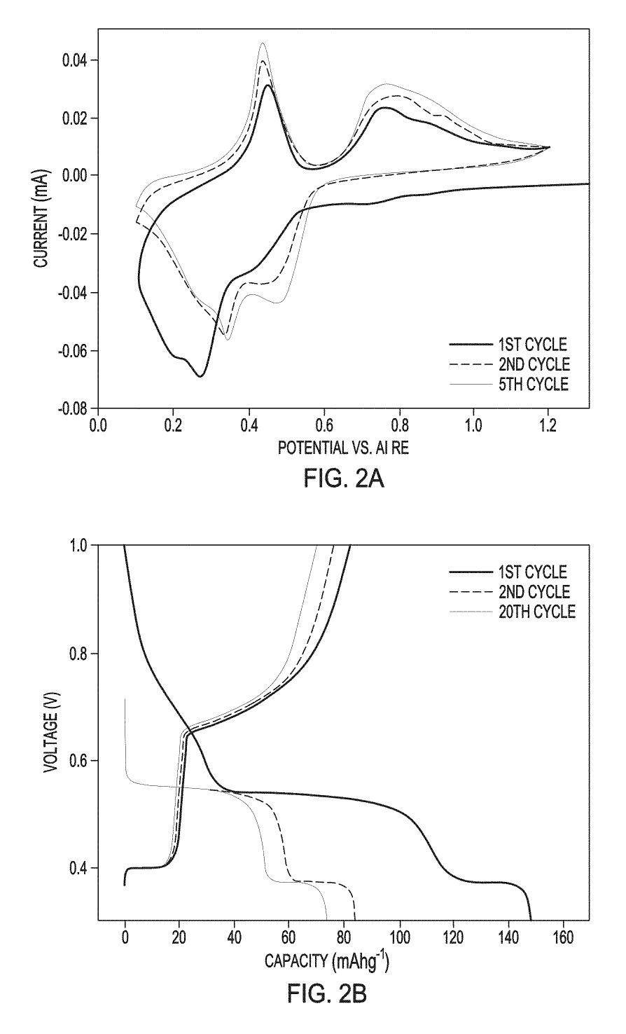

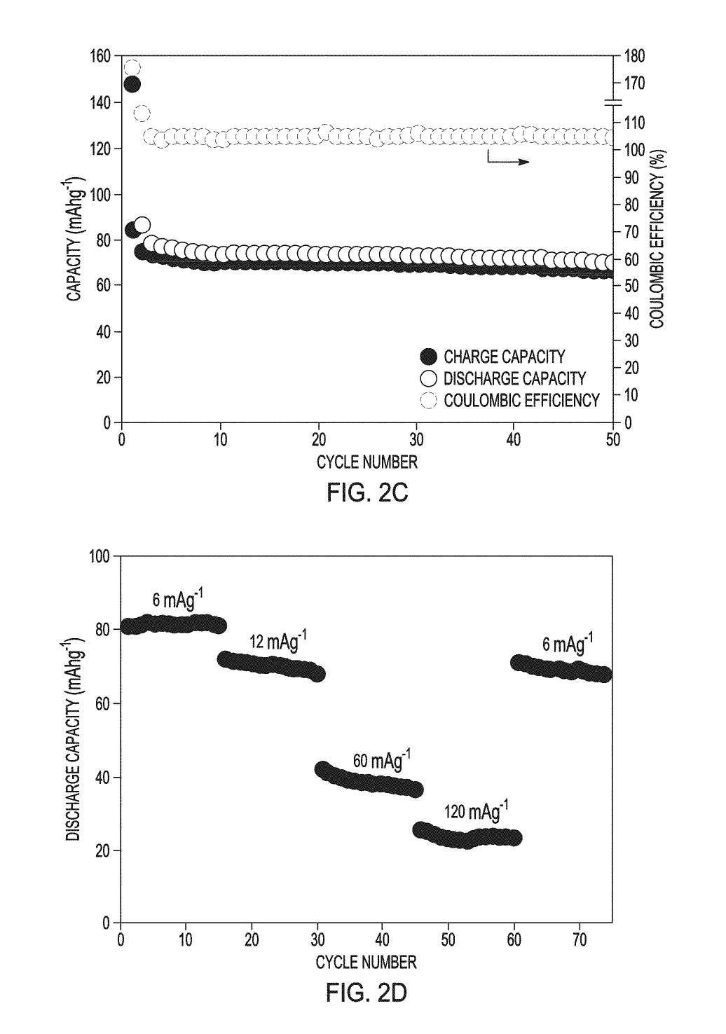

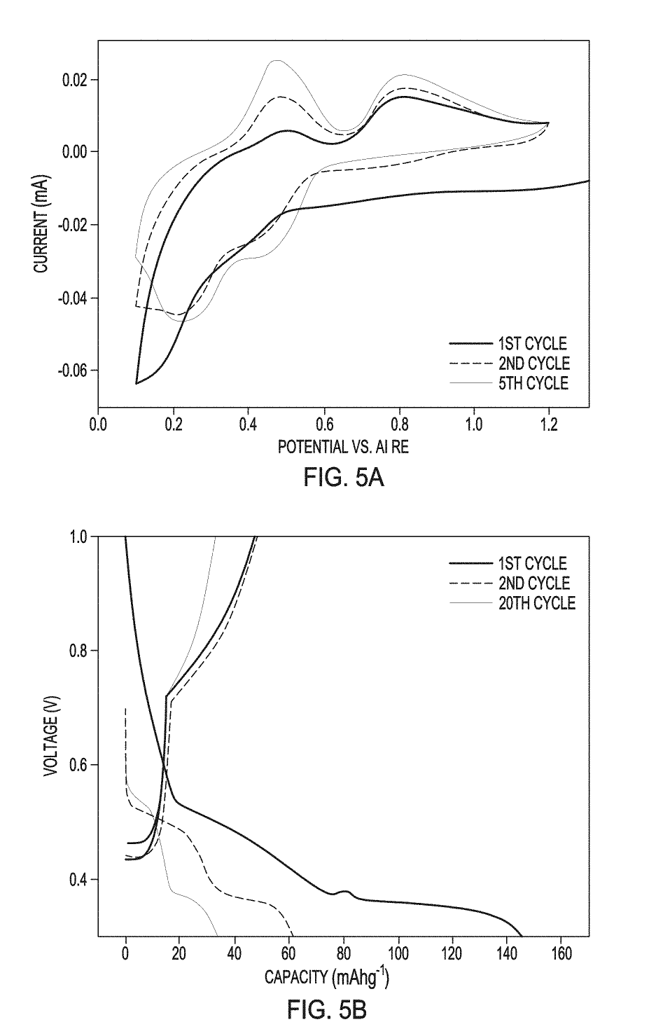

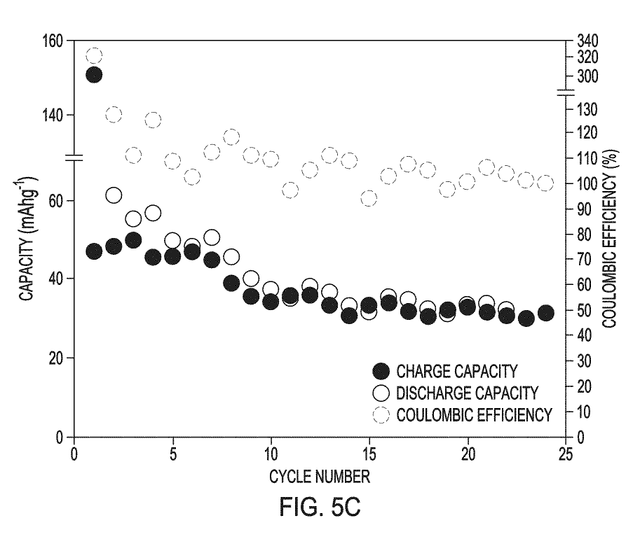

The results of the electrochemical characterizations of Mo₆S₈ vs Al are presented in FIGS. 2A-2D. Cyclic voltammetry (CV, scan rate=0.1 mV s−1) were first performed at both room temperature (FIGS. 5A-5C) and 50° C. The electrochemical characteristics at these two temperatures are essentially the same; however, the elevated temperature apparently improved the electrochemical reaction kinetics indicated by the distinct shape of the current peaks and the narrowed redox peak separation as shown in FIG. 2A. Therefore, the presented electrochemical studies were all performed at 50° C. The room temperature electrochemical characterizations are shown as a comparison in the Supporting Information. It is worth noting that the ionic conductivity of the AlCl₃-[BMIm]Cl electrolyte is 2.21×10⁻² S cm ⁻¹ at room temperature and 3.29×10−2 S cm−1 at 50° C., both of which are sufficient for facile ion conducting. Therefore, the sluggish kinetics at room temperature may not be due to the low conductivity of the electrolyte but to the large particle size of Mo₆S₈, i.e., long solid-state diffusion pathway of Al.

As shown in FIG. 2A, the stabilized CV scans of Mo₆S₈ vs Al demonstrate two cathodic peaks at 0.50 and 0.36 V and two corresponding anodic peaks at 0.40 and 0.75 V, indicating a two-step electrochemical reaction between Mo₆S₈ and Al. We speculate that these two pairs of CV peaks represent the Al intercalation/extraction in/from the two different sites in Mo₆S₈, which is verified by the crystallographic study described in the later section. A small additional cathodic peak at 0.20 V in the first scan and 0.26 V in the following scans, respectively, is also observed. This peak may be due to certain irreversible decomposition of the electrolyte, which is under investigation.

FIG. 2B depicts the representative galvanostatic charge-discharge (GCD) curves of the Al—Mo₆S₈ coin cell with a current density of 12 mA g−1 at 50° C. at the 1st, 2nd, and 20^{th} cycles. The first discharge curve demonstrates two distinct plateaus at 0.55 and 0.37 V, which are consistent with the two cathodic peaks in the CV. These two discharge plateaus also indicate two phase-transition processes induced by the Al intercalation. The Al intercalation capacity in the first discharge is 148 mA h g⁻¹ (based on the chemical formula weight of Mo₆S₈). However, the first charging capacity is only 85 mA h g⁻¹. By comparing the length of the discharge plateaus with the corresponding charged ones, it is clear that the intercalated Al atoms are partially trapped in the Mo₆S₈ crystal lattice. Furthermore, the voltage slope from 0.75 to 0.55 V in the first discharge curve, which may be due to the solid-solution Al intercalation prior to phase-transition, is significantly reduced in the subsequent discharges, which also contributes to the irreversible capacity.

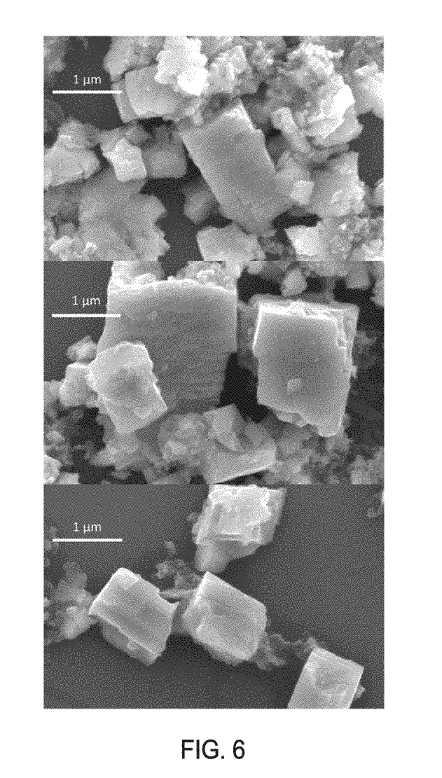

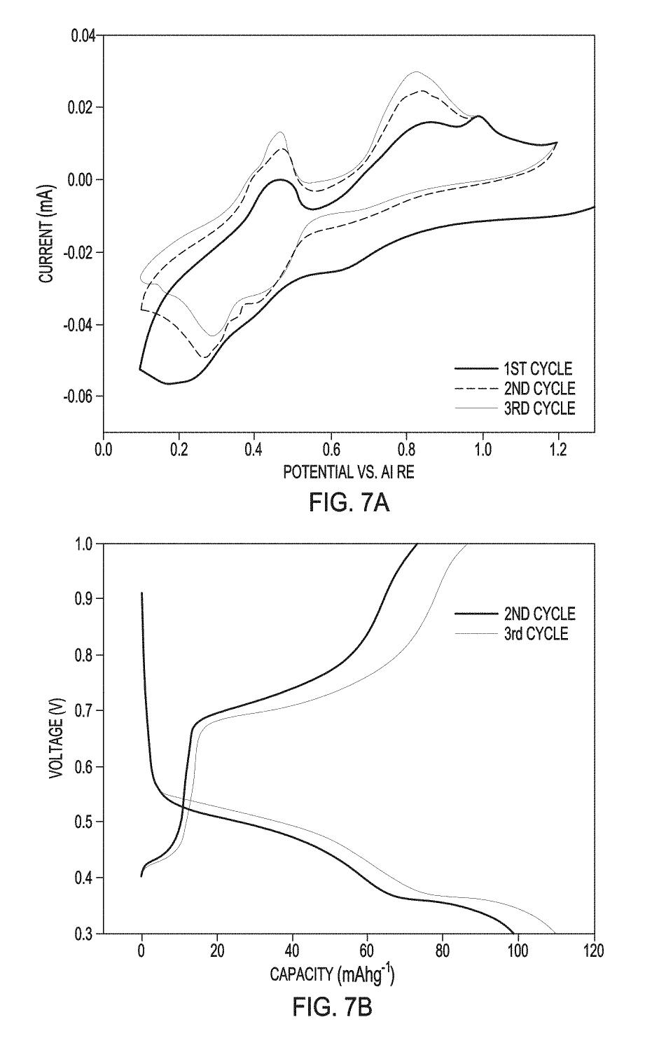

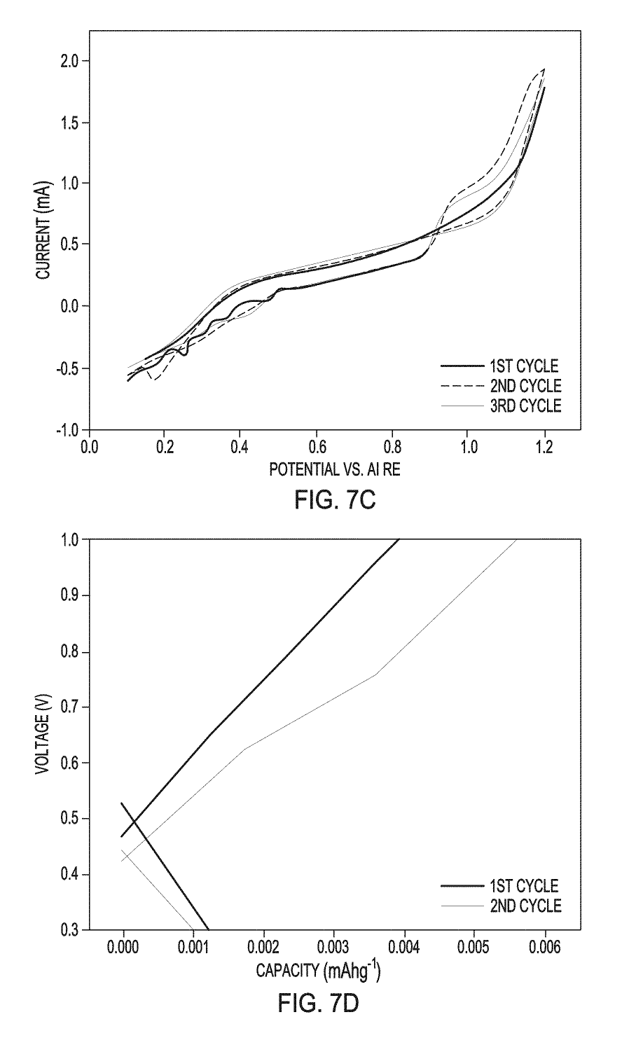

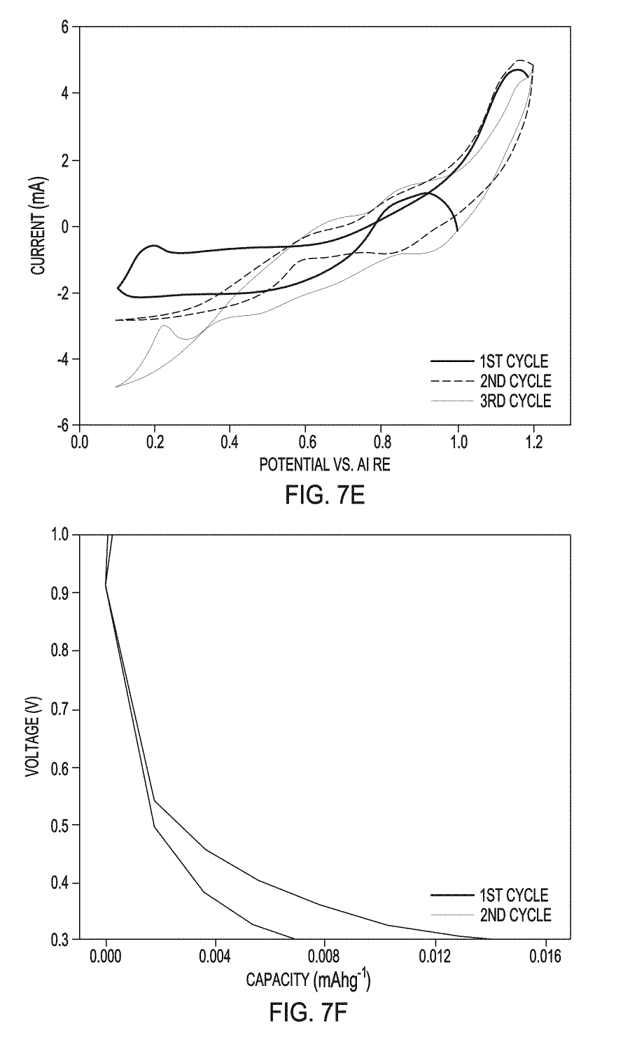

We attribute the irreversible capacity to the electrostatic attraction between Al cations and the sulfide anionic framework. Nevertheless, the Mo₆S₈ electrode exhibits promising cycle stability: as shown in FIG. 2C, the discharge capacity of Mo₆S₈ is quickly stabilized after the first cycle and retains a capacity of 70 mA h g−1 after 50 cycles. After cycling, the morphology of the Mo₆S₈ particles was analyzed with SEM. As shown in FIG. 6, cracks on the cycled Mo₆S₈ particles are visible, which suggests the large mechanical stress imposed by the Al intercalation. Therefore, the physical degradation of the Mo₆S₈ particles during cycling may be one of the reasons for the slow capacity fading. Another reason may still be the gradual Al trapping in Mo₆S₈ crystal, which is suggested by the >100% Coulombic efficiency (intercalation/extraction >1). The Al—Mo₆S₈ coin cells were also discharged/charged at different current densities from 6 mA g⁻¹ to 120 mA g⁻¹. As shown in FIG. 2Dd, the Mo₆S₈ electrode can deliver a discharge capacity of 40 mA h g⁻¹ and 25 mA h g⁻¹ at current densities of 60 mA g⁻¹ and 120 mA g⁻¹, respectively. In addition, the discharge capacity can be recovered to 70 mA h g⁻¹ after changing the current density from 120 mA g⁻¹ back to 6 mA g⁻¹. The Al—Mo₆S₈ intercalation behaviors in electrolytes with different AlCl₃/[BMIm]Cl ratio (acidity) are shown in FIGS. 7A-7F.

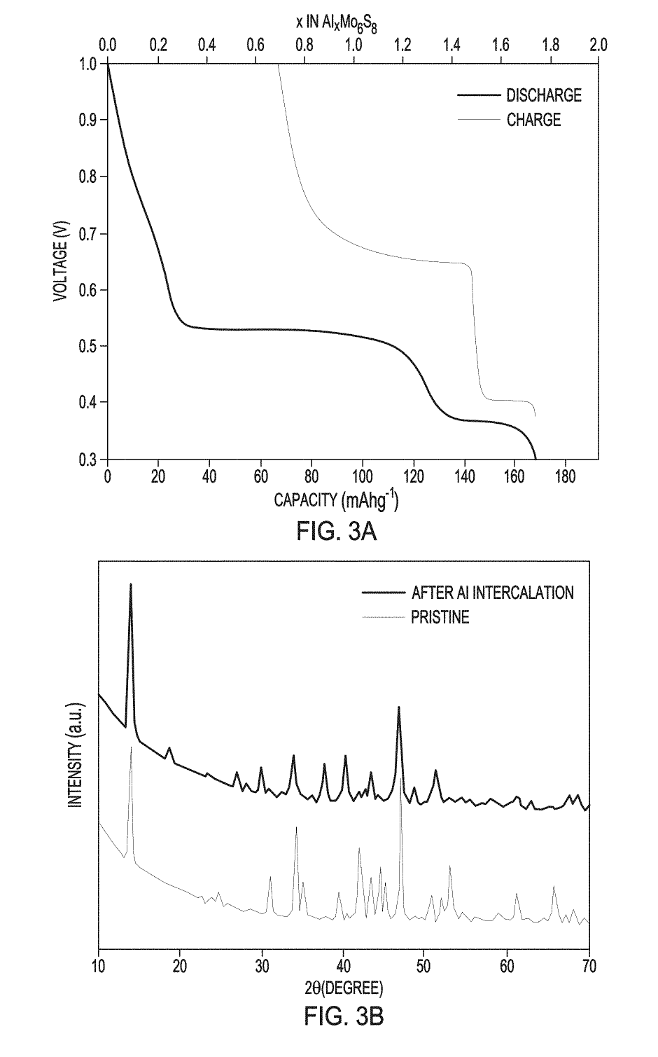

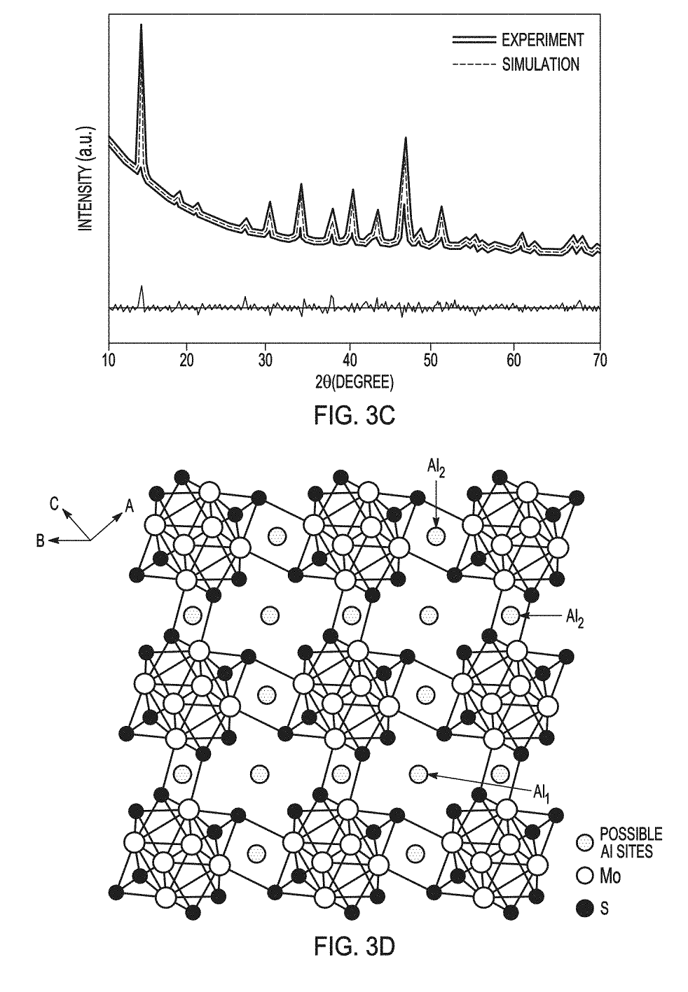

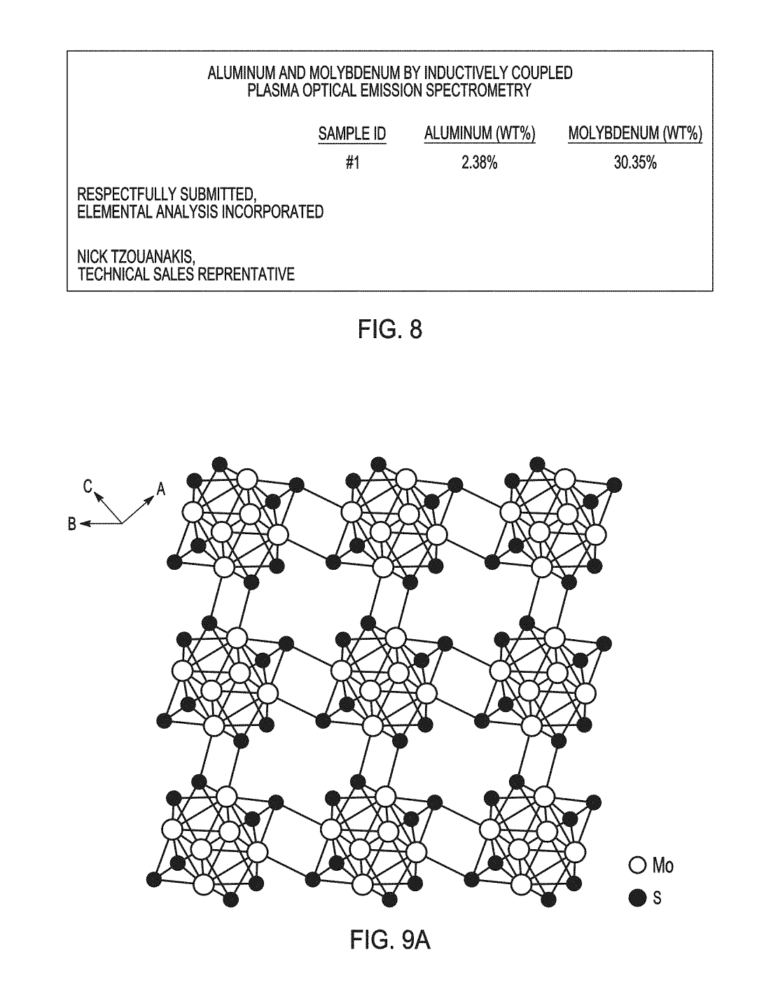

To further analyze the composition and the crystal structure of the Al intercalated Mo₆S₈ (AlₓMo₆S₈), discharge-charge chronopotentiometry was performed using a small current density of 2.4 mA g⁻¹. As shown in FIG. 3A, the electrochemically achievable Al interaction capacity is 167 mA h g⁻¹, which is equivalent to a formula of Al_{1.73}Mo₆S₈. The Al intercalated Mo₆S₈ sample was subsequently analyzed with the inductively coupled plasma optical emission spectrometry (ICP-OES) to verify the Al content. The ICP-OES result (FIG. 8) demonstrates that the chemical composition of the Al intercalated Mo₆S₈ is Al_{1.67}Mo₆S₈, which is in great agreement with the composition obtained from the chronopotentiometry experiment. Meanwhile, the charge curve in FIG. 3A confirms that part of the Al atoms is trapped resulting in a chemical formula of Al_{0.69}Mo₆S₈ after Al extraction. The XRD pattern of the Al intercalated Mo₆S₈ from the chronopotentiometry described above is shown in FIG. 3B, which is distinctly different from that of the pristine Mo₆S₈. Rietveld refinement (TOPAS program) was performed to obtain the crystal structure parameters of the Al intercalated Mo₆S₈. Chevrel phase Ga₂Mo₆S₈ was used as the starting structural model. As shown in FIG. 3C, the refinement XRD pattern (simulation) is in excellent agreement with the experimental data (Experiment). The Rietveld refinement results including various agreement factors are listed in Table 1.

TABLE 1
Lattice Parameters of Al₂Mo₆S₈

| | |
|---|---|
| space group: R3H | Rₑₓₚ: 2.37 |
| a (Å): 9.6356 | R_{wp}: 4.58 |
| c (Å): 9.9942 | Rₚ: 3.40 |
| cell volume (Å³): 803.5904 | R-Bragg: 3.312 |
| crystallite size (nm): 145.2 | GOF: 1.93 |

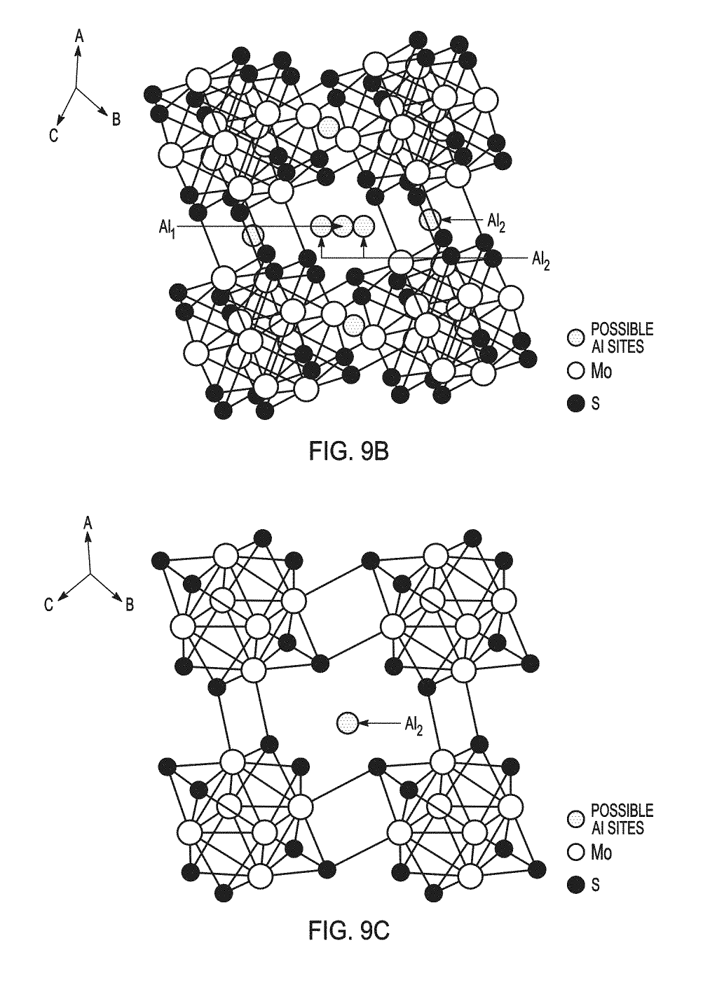

The refinement result supports the hypothesis that Al atoms are intercalated into two different sites in the Mo₆S₈ lattice with a theoretical formula of Al₂Mo₆S₈ at full Al intercalation (theoretical capacity of 193 mA h g⁻¹). The crystal structure of Al₂Mo₆S₈ is illustrated in FIG. 3D, showing the packing of Mo₆S₈ units and Al atoms intercalated in two different sites. The larger site (Al₁) can be seen as a cubic center of a hexahedron with eight Mo₆S₈ units as the vertices, while the smaller site (Al₂) can be seen as face centered. Crystallographic views of Al₂Mo₆S₈ from more directions are shown in FIGS. 9A-9C. Al can be more easily intercalated into the Al₁ sites leading to a stoichiometric formula of AlMo₆S₈ (corresponding to the first discharge plateau).

As for the Al₂ sites, although we can identify six available sites on the faces of the hexahedron mentioned above, the strong electrostatic force from the Al cation with three positive charges can only allow filling in two of the six sites, which also gives a stoichiometric formula of AlMo₆S₈ (corresponding to the second discharge plateau). Therefore, the fully Al intercalated formula is Al₂Mo₆S₈, which is consistent with the refinement result. The discharge and charge reactions are proposed as follows:

Al+7[AlCl₄]⁻ [symbol] 4[Al₂Cl₇]⁻+3e⁻ (anode)

8[Al₂Cl₇]⁻+6e⁻+Mo₆S₈ ⇄ Al₂Mo₆S₈+14[AlCl₄]⁻ (cathode)

In conclusion, Mo₆S₈ shows unambiguous electrochemical activity for reversible Al intercalation and extraction with good cycle stability. In addition to the electrochemical analysis, XRD investigations provide the crystallographic information on the Al intercalated Mo₆S₈. We conclude that the theoretical formula of fully Al intercalated Mo₆S₈ is Al₂Mo₆S₈ with Al occupying two different sites in the Mo₆S₈ crystal lattice. From the practical aspect, the theoretical material-level specific energy of a battery with Al anode and Mo₆S₈ cathode is approximately 90 W h kg⁻¹ (assuming 0.5 V nominal voltage), which can he an attractive alternative for large-scale energy storage technologies. Further investigation is under way to understand the Al trapping mechanism and to address the large irreversible capacity in the first cycle.

### EXPERIMENTAL

### Synthesis of Chevrel Phase Mo₆S₈

All reagents were used after purchase without further purification unless otherwise noted. In a typical synthesis of Mo₆S₈, stoichiometric amounts of anhydrous copper(II) chloride (CuCl₂, 0.3442 g, 2.56 mmol, Sigma Aldrich 99.995%) and ammonium tetrathiomolybdate ((NH₄)₂MoS₄, 2.000 g, 7.68 mmol; Fisher Scientific 99.99%) were dissolved in 65 mL N,N-Dimethylformamide (DMF, Sigma Aldrich 99.8%) and the mixture was stirred for 30 min at room temperature. The resultant solution was then heated at 90° C. for 6 hours under continuous argon bubbling. After the reaction was completed, the solution was filtered, and then 325 mL THF (1:5 by volume) was added immediately to the filtrate to initiate precipitation. The precipitate was collected by centrifuge, washed with THF and dried in the vacuum oven at 150° C. overnight. The dried solid agglomerate was then ground and heated in a tube furnace at 1000° C. for 7 hour under reducing environment (95 vol. % argon and 5 vol. % H₂) to yield Chevrel phase Cu₂Mo₆S₈. The obtained Cu₂Mo₆S₈ was then added into 20 mL 6M HCl solution. Oxygen was bubbled into the solution for 8 hours while stirring to leach out Cu to yield Mo₆S₈. After the reaction, the obtained Mo₆S₈ was centrifuged, washed with adequate amount of deionized water, and dried in vacuum oven at 50° C. overnight.

### Electrochemical Analysis.

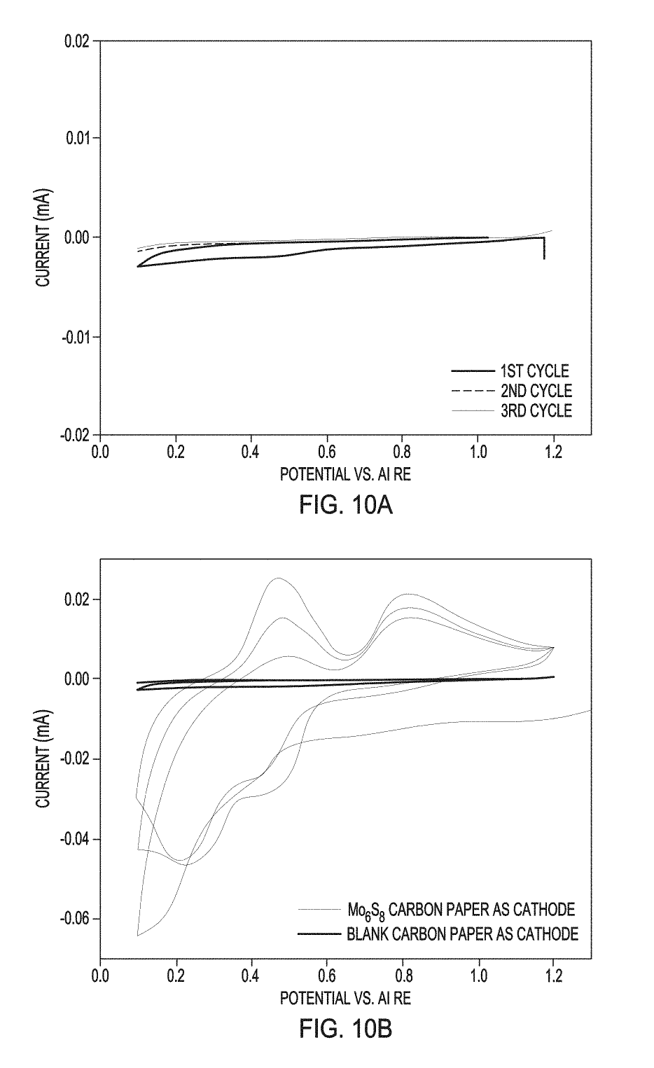

For battery preparation, Al foil with 0.2 mm thickness (Alfa Aesar 99.9999%) was used as the anode. Cathode was fabricated by coating Mo₆S₈ slurry onto carbon paper current collector (Fuel Cell Earth). The carbon paper current collector was demonstrated to be electrochemically inert in the applied potential window as shown in FIGS. 10A-10B. The slurry was made by mixing 80 wt. % Mo₆S₈, 10 wt. % carbon black, and 10 wt. % polyvinylidene fluoride in N-Methyl-2-pyrrolidone solution via a mechanical mixer for 5 min in an argon-filled glovebox.

A single Whitman® glass fiber filter was used as the separator. The electrolyte was synthesized by slowly adding anhydrous AlCl₃ (Sigma Aldrich 99.99%) into [BMIm]Cl (Sigma Aldrich 99.0%) with a molar ratio of 1.5:1 while stirring. Both AlCl₃ and [BMIm]Cl were further dried in vacuum oven at 150° C. overnight prior mixing. CR2016 coin cells were assembled in the argon filled glovebox. To prevent potential corrosion from the acidic electrolyte, titanium foil was used as lining at both electrodes inside the stainless steel coin cell case.

The cyclic voltammetry (CV) of Al deposition-dissolution and the galvanostatic Al deposition were performed in three-electrode cells with a Gamry potentiostat/galvanostat/ZRA (Interface 3000) using Nickel (0.025 mm thick, Alfa Aesar 99.5%) working electrode and two Al wires (2.0 mm diameter, Alfa Aesar 99.9995%) as the counter and the reference electrodes, respectively. The CV scan rate for Al deposition-dissolution experiment was 100 mV s−1 from −1.0 V to 2.0 V vs. Al. A constant current density of −5 mA cm⁻² was applied in electrochemical Al deposition experiment. The ionic conductivity of the AlCl₃-[BMIm]Cl electrolyte at room temperature and 50° C. was obtained from the resistance measurement in a cell with two parallel Pt electrodes.

The cell constant was obtained through calibration using standard aqueous KCl solutions. The resistance was measured with a Gamry potentiostat/galvanostat/ZRA (Interface 1000). The GCD experiments of Al—Mo₆S₈ batteries were performed on an Arbin battery test station, and the CV analysis of Al—Mo₆S₈ was conducted on a Gamry Interface 1000 with a scan rate of 0.1 mV s⁻¹.

### Materials Characterization.

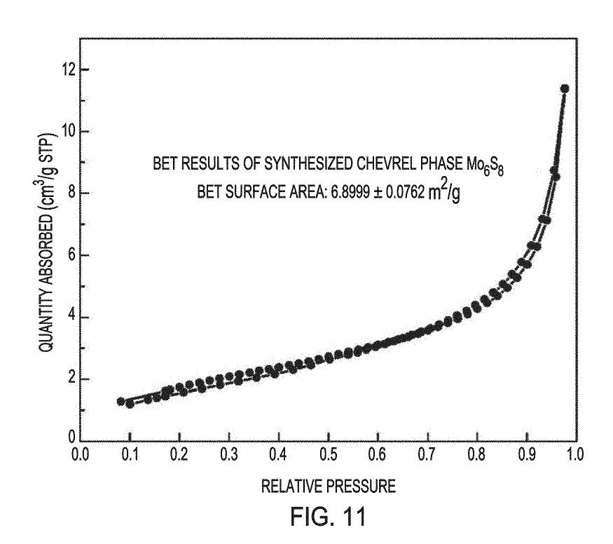

The surface area of the synthesized Mo₆S₈ was measured with nitrogen adsorption-desorption method, and the isotherms are shown in FIG. 11. The BET surface area of the Mo₆S₈ is 6.9 m2 g⁻¹. The X-ray diffraction (XRD) was conducted using PAN alytical EMPYREAN instrument (45 kV/40 mA) with a Cu—Kα source. The inductively coupled plasma optical emission spectrometry (ICP-OES) of Al intercalated Mo₆S₈ was performed by Elemental Analysis, Inc. (Lexington, Ky.). Prior to the ICP-OES analysis, the Al—Mo₆S₈ coin cell was dissembled in the argon-filled glovebox. The electrode containing Mo₆S₈ particles was first soaked in 3 ml NMP and sonicated for 5 minutes. The NMP dissolved the PVDF polymer binder and suspended the powder (Mo₆S₈ and carbon black) in the solution. The suspension was centrifuged and the collected powder was further washed three times with NMP followed by adequate THF for three times to remove the electrolyte residue. Finally, the powder was vacuum dried at 60° C. overnight. The Rietveld refinement was performed using the TOPAS program. Scanning electron microscopy (SEM) was performed with a FEI XL30-FEG (10 kV/192 μA).

FIGS. 4A-4B show (a) The CV scan of Al deposition-dissolution on Ni working electrode in the AlCl₃-[BMIm]Cl electrolyte (AlCl₃:[BMIm]Cl=1.5:1). The CV curves demonstrate facile Al deposition-dissolution with small deposition overpotential of 200 mV; (b) the SEM image of the deposited Al on Ni, inset shows the XRD of the deposited Al.

FIGS. 5A-5C show electrochemical characterization of the Al—Mo₆S₈ cells at room temperature: (a) The 1^{st}, 2^{nd} and 5^{th} CV curves of Mo₆S₈ vs. Al with a scan rate of 01 mV s⁻¹ in the range of 0.1 V to 1.2 V. (b) First two GCD curves of Al—Mo₆S₈ cell with a current density of 12 mA g⁻¹ in the voltage window of 0.3 V to 1.0 V. (c) Cycle stability of first 24 cycles at room temperature with discharge/charge rate of 12 mA g⁻¹

FIG. 6 shows SENT images of the Chevrel phase Mo₆S₈ after 50 cycles of galvanostatic charge-discharge with a current density of 12 mA g⁻¹

FIGS. 7A-7F show electrochemical behaviors of Al—Mo₆S₈ in electrolytes with different AlCl₃/[BMIm]Cl ratio at 50° C.: AlCl₃:[BMIm]Cl=1.1:1 (top), AlCl₃:[BMIm]Cl=1:1 (middle) and AlCl₃:[BMIm]Cl=0.9:1 (bottom). The CV scan rate is 0.1 mV s⁻¹ and the GCD current density is 12 mA g⁻¹. Comparing with the electrolyte (AlCl₃:[BMIm]Cl=1.5:1) used in the study, the electrolyte with AlCl₃:[BMIm]Cl=1.1:1 is still Lewis acidic containing active species [Al₂Cl₇]⁻. This acidic electrolyte is still able to enable the reversible Al intercalation-extraction as indicated by the CV and GCD curves. It is also noticed that the CV peak separation and charge-discharge hysteresis become larger, which can be attributed to the lower acidity (i.e. lower concentration of [Al₂Cl₇]⁻). The electrolyte with AlCl₃:[BMIm]Cl=1:1 is neutral without [Al₂Cl₇]⁻ (species in the electrolyte are [AlCl₄]⁻ and [BMIm]⁺). It does not enable any electrochemical activity between Al and Mo₆S₈, noticing the current of the CV and the capacity demonstrated in the GCD are extremely low. The similar non-active behavior is also demonstrated by the Lewis base electrolyte (AlCl₃:[BMIm]Cl=0.9:1).

FIG. 8 shows a report of Al and Mo contents via ICP-OES from Elemental Analysis, Inc. The rest content in the sample includes sulfur, carbon black, and polymer binder residue.

FIGS. 9A-9C show (a) Crystal structure of the pristine Chevrel phase Mo₆S₈. (b) Schematic of Chevrel phase Mo₆S₈ and possible Al intercalation sites. (c) Schematic of the smaller Al intercalation site (inner site) which can be interpreted as in the center of the square with four Mo₆S₈ clusters as vertices.

FIGS. 10A-10B show (a) Electrochemical stability test of the carbon paper current collector via CV (0.1 mV s⁻¹, Al RE and Al CE) at room temperature. The scan rate and experiment set up are the same as when using Mo₆S₈ cathode. (b) Comparison between CV curves of Mo₆S₈ on carbon paper vs. Al and blank carbon paper vs. Al at room temperature. These plots clearly demonstrated the electrochemical stability of the carbon paper current collector.

FIG. 11 shows N₂ adsorption-desorption isotherms of the synthesized Mo₆S₈ powder.

Although Lithium-ion batteries have made significant positive impact on portable electronics and electric vehicle industries, the feasibility of wide deployment of lithium-based batteries for land-based renewable energy storage and grid applications may be questionable due to the limited lithium resource, the resource geographic distribution, and the cost of lithium mining and recycling. Therefore, alternative rechargeable battery technologies based on abundant elements need to be developed for sustainable energy storage. Among the potential candidates, aluminum (Al) may be the ultimate choice as the anode material: Al is not only the most abundant metal in earth's crust, but also has attractive capacity due to its trivalency. Al has the second highest specific capacity of 2980 mA h g−¹ (Li has 4634 mA h g−¹) and the highest capacity density of 8046 mA h cm⁻³ (Li has 2456 mA h cm−³) among all metal anodes.

The most developed Al battery at current stage is the Al-air technology, which is essentially a fuel cell utilizing Al metal as the fuel, concentrated aqueous alkaline (KOH) solution as the electrolyte, and air (O₂) as the oxidant. The Al-air battery is non-rechargeable due to the high irreversibility of Al(III) reduction in the aqueous electrolyte: The electrolysis of water is inevitable due to its preferential potential comparing to Al(III) reduction. Besides Al-air, there are a number of other Al batteries using aqueous electrolyte with different cathode materials including manganese oxide (MnO₂), solver oxide, hydrogen peroxide, sulfur, ferricyanide and nickel oxide hydroxide, which are all primary batteries.

To date, there were only scarce investigations on rechargeable Al batteries with little success. Matsuda and coworkers studied the anodic dissolution activity of Al in a number of aluminum chloride (AlCl₃) solutions in organic solvents. Their results indicated that AlCl₃ saturated in formamide (FA) had the lowest Al dissolution overpotential followed by 1 M AlCl₃ in propylene carbonate (PC) and 1 M AlCl₃ in tetrahydrofuran (THF). However the conductivity of FA-based electrolyte was too low for sufficient current delivery. A number of combinations of salts and organic solvents have been investigated including AlCl₃ and tetraethylammonium chloride ((C₂H₅)₄NCl) inγ-butyrolactone (γ-BL) and acetonitrile (ACN), respectively. Their results demonstrated that the electrolyte composed of 0.3 M (C₂H₅)₄NCl in ACN with 10 mM mercury(II) acetate had the lowest Al dissolution overpotential. Based on this electrolyte, a number of potential cathode materials were tested including MnO₂, titanium disulfide (TiS₂), molybdenum disulfide (MoS₂), vanadium(V) oxide (V₂O₅) and fluorinated graphite (FG) with Al metal anode. Among these materials, both V₂O₅ and FG demonstrated slender electrochemical activity toward Al (presumably Al intercalation) indicated by short discharge plateaus in their galvanostatic charge-discharge (GCD) curves, although there was no direct evidence of Al intercalation in either V₂O₅ or FG. Furthermore, the discharge reaction of neither V₂O₅ nor FG with Al was reversible.

One of the decisive disadvantages of Al electrolytes based on organic solvents is the sluggish electrochemical Al deposition-dissolution. On the other hand, facile Al deposition-dissolution can be achieved in high-temperature molten salt electrolytes, which are used in today's production of Al (electrowinning). With electrolytes based on molten salts, various metal sulfides including TiS₂, iron disulfide (FeS₂), iron(II) sulfide (FeS), chromium sulfide (Cr₂S₃), ternary sodium iron sulfide (NaFeS₂), nickel sulfide (NiS₂) and amorphous molybdenum(VI) sulfide (MoS₃) were investigated as cathode materials with Al anode representative study was reported, in which a FeS₂ cathode was investigated in high-temperature molten salt electrolytes composed of AlCl₃—NaCl-1-butylpyridinium and AlCl₃—LiCl-1-butylpyridinium. The Al—FeS₂ pair demonstrated somewhat reversible discharge-charge reaction at high temperature above 100° C., indicating the potential of metal sulfides as cathode materials in rechargeable Al batteries. In the past two decades, electrolytes based on ionic liquids (ILs) have been demonstrated for reversible Al deposition-dissolution at room temperature, particularly for systems based on AlCl₃ and organic salts such as 1-butylpyridinium chloride ([BP]Cl), 1-ethyl-3-methyllimidazolium chloride ([EMIm]Cl), and I-butyl-3-methyllimidazolium chloride ([BMIm]Cl). With IL-based electrolytes, V₂O₅, FG and chloroaluminate-doped conductive polymers were attempted as cathode materials against Al anode. Most recently, an Al rechargeable battery with graphitic carbons cathode in IL-based electrolytes was reported.

For the first time, we demonstrate a new prototype rechargeable Al battery comprised of Chevrel phase molybdenum sulfide (Mo₆S₈ as the intercalation-type cathode, Al metal as the anode, and a mixture of AlCl₃ and 1-butyl-3-methyin1idazolium chloride (AlCl₃-[BMIm]Cl) as the electrolyte. Mo₆S₈ has a unique crystal structure of stacked Mo₆S₈ blocks composed of an octahedral cluster of Mo atoms inside a sulfur anion cubic cell. Aurbach and coworkers first demonstrated Mo₆S₈ as a cathode material for rechargeable magnesium-ion batteries. ll⁶1

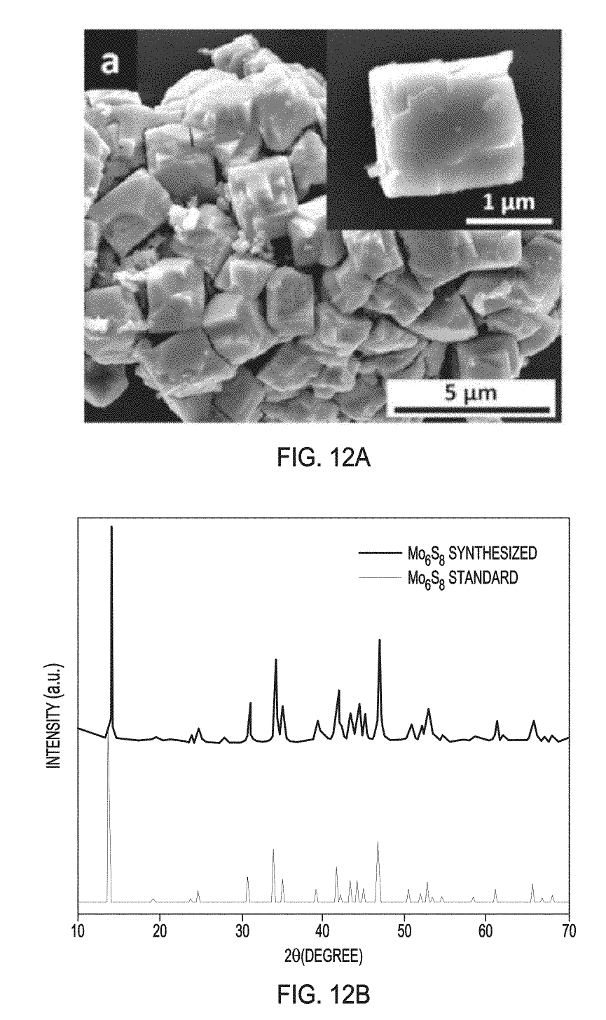

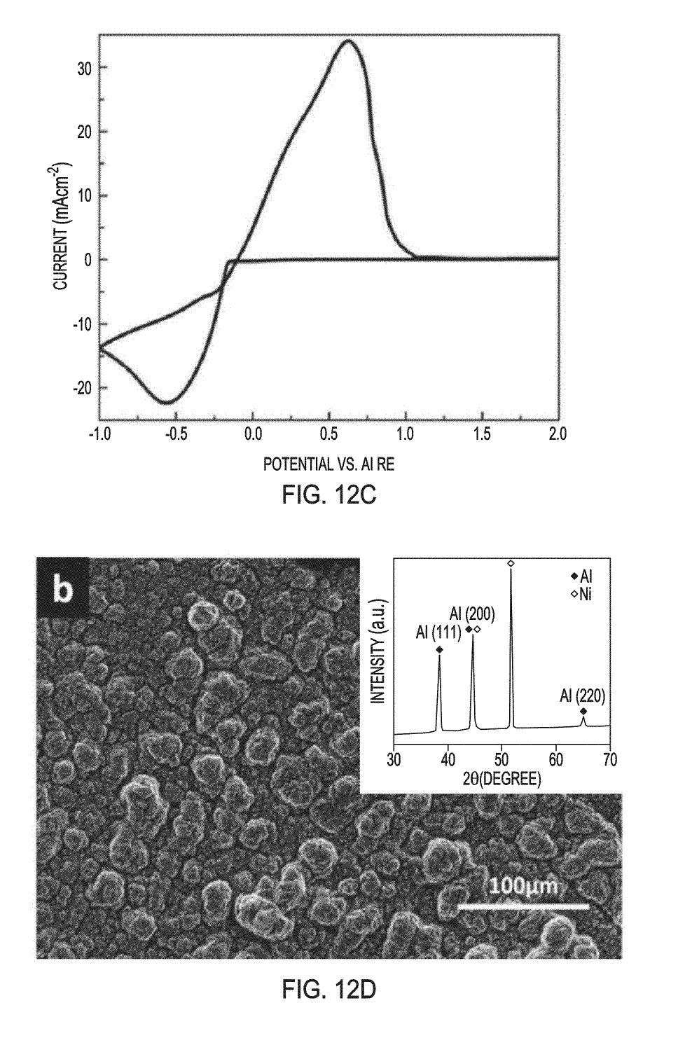

FIG. 12A shows the scanning electron microscopy (SEM) image of the Mo₆S₈ particles synthesized through a precipitation method modified from the reported works, particle shape is cubic and the typical particle size is within the range of 1 to 2 μm. FIG. 12B shows the X-ray diffraction (XRD) pattern which is in excellent agreement with pure Mo₆S₈ without the typical impurity of MoS₂. The IL electrolyte was prepared by mixing AlCl₃ with [BMIm]Cl with a molar ratio of 1.5:1. It was known that reversible Al deposition-dissolution could only be achieved in a Lewis acidic electrolyte composed of AlCl₃ and an IL with molar ratio higher than 1, and the electroactive species is [AlCl₃]″ anion. FIG. 12E shows the cyclic voltammetry (CV) of Al deposition-dissolution on a nickel (Ni) working electrode in the prepared AlCl₃-[BMIm]Cl electrolyte with an Al counter electrode and an Al reference electrode. The CV curves demonstrate facile Al deposition-dissolution with small deposition overpotential of 200 mV. The SEM image of the deposited Al on Ni is shown in FIG. 12D, and the inset shows the XRD of the deposited Al.

The electrochemical properties of the Al—Mo₆S₈ batteries were evaluated as 2016 type coin cells and the results are presented in FIGS. 2A-2D. CV (scan rate=0.1 mV s⁻¹ were first performed at both room temperature (FIGS. 5A-5C) and 50° C. as shown in FIG. 2A. The electrochemical characteristics at these two temperatures are essentially the same, however, the elevated temperature apparently improved the charge transfer kinetics indicated by the distinct shape of the current peaks and narrowed redox peak separation. Therefore, the presented electrochemical characterizations in this study were all performed at 50° C. The room temperature electrochemical characterizations were also conducted and shown as comparison in the supporting information. As shown in FIG. 2A, the CV characteristic of Mo₆S₈ vs. Al is stabilized after the first cycle. The stabilized CV curves demonstrate two cathodic peaks at 0.50 V and 0.36 V and two corresponding anodic peaks at 0.40 V and 0.75 V, indicating a two-step electrochemical reaction between Mo₆S₈ and Al. It is known that there are two types of sites available to accommodate small cations such as Li+, Cu+, and Mg²⁺ in the Mo₆S₈ lattice. _{[}2.0²¹¹ We speculate that the observed two pairs of CV peaks represent the Al intercalation/extraction in/from these two sites at different potential, which is verified by the crystallographic study described in the later section.

FIG. 2B depicts the representative GCD curves of the Al—Mo₆S₈ coin cell with a current density of 12 mA g″¹ at 50° C. at the 1″, 2″d and 20 cycles. The first discharge curve demonstrates two distinct plateaus at 0.55 V and 0.37 V, which are consistent with the two cathodic peaks in the CV. These two chronopotentiometric plateaus also indicate two phase-transition processes induced by the Al intercalation into the two types of sites. The Al intercalation capacity in the first discharge is 148 mA h g⁻¹, however, the first charging capacity is only 85 mA h g⁻¹. The large irreversible capacity may be partly due to the strong electrostatic attraction between Al cations and the sulfide anionic framework: certain Al population can be trapped in the host sites after the first intercalation. If assuming the length of the discharge and charge plateaus represents the relative extent of Al intercalation in and extraction from the two-phase regions, it can be concluded that Al ions in both sites are partially trapped. Furthermore, the voltage slope from 0.75 V to 0.55 V in the first discharge curve, which may be due to the solid-solution Al intercalation prior to phase-transition, is significantly reduced in the subsequent discharges, which also contributes to the irreversible capacity. Nevertheless, this prototype rechargeable Al battery exhibits promising cycle stability: as shown in FIG. 2C, the discharge capacity of Mo₆S₈ is quickly stabilized after the first cycle, and retaining a capacity of 70 mA h g⁻¹ after 50 cycles. The Al—Mo₆S₈ coin cells were also discharged/charged at different current densities from 6 mA g″¹ to 120 mA g⁻¹. As shown in FIG. 2D, the Mo₆S₈ cathode can deliver a discharge capacity of 40 mA h g⁻¹ and 25 mA h g⁻¹ at current densities of 60 mA g⁻¹ and 120 mA g⁻¹, respectively. In addition, the discharge capacity can be recovered to 70 mA h g⁻¹ after changing the current density from 120 mA g⁻¹ back to 6 mA g⁻¹.

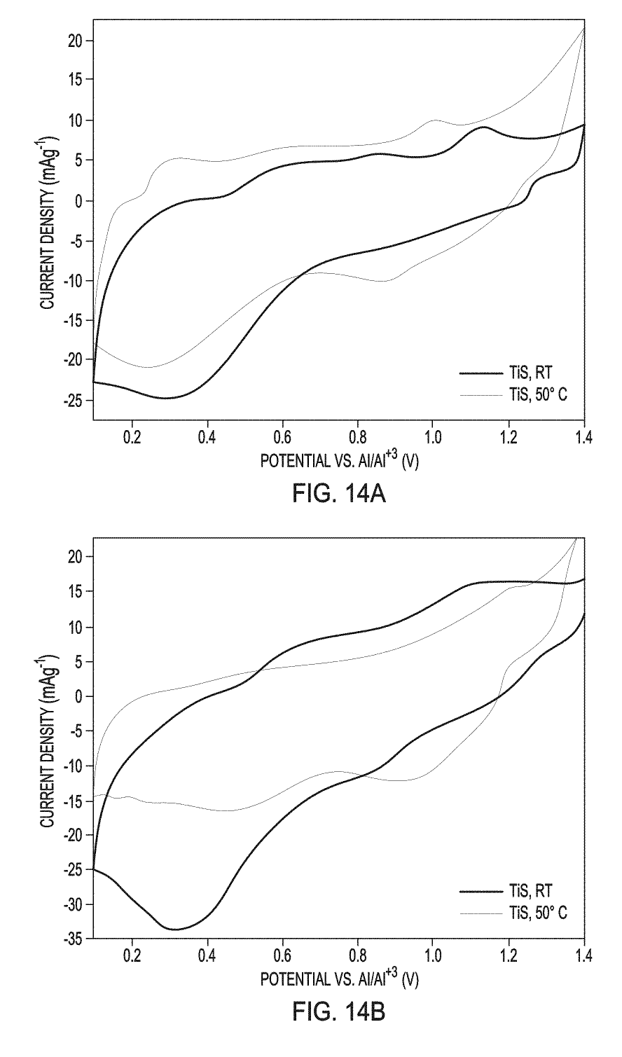

To further analyze the composition and the crystal structure of the Al intercalated Mo₆S₈(AlₓMo₆S₈), discharge-charge chronopotentiometry was performed using a small constant current density of 2.4 mA g⁻¹ at 50° C. As shown in FIGS. 14A-14B, the electrochemically achievable Al interaction capacity is 167 mA h g⁻¹ (based on the chemical formula weight of Mo₆S₈), which is equivalent to Al_{1.73}Mo₆S₈. The Al intercalated Mo₆S₈ sample was subsequently analyzed with inductively coupled plasma optical emission spectrometry (ICP-OES) to verify the Al content. The ICP-OES result (FIG. 8) demonstrates that the chemical composition of the Al intercalated Mo₆S₈ is Al_{1.61}Mo₆S₈, which is in great agreement with the composition obtained from the chronopotentiometry experiment. Meanwhile, the charge curve in FIG. 3A confirms that part of the Al atoms is trapped resulting in a chemical formula of Al_{0.69}Mo₆S₈ after Al extraction.

The XRD pattern of the Al intercalated Mo₆S₈ from the chronopotentiometly described above is shown in FIG. 3B. It is clear that the XRD pattern of Al intercalated Mo₆S₈ is distinctly different from that of the pristine Mo₆S₈. Rietveld refinement was used to obtain the crystal structure parameters of the Al intercalated Mo₆S₈. As shown in FIG. 3C, the refinement XRD pattern (simulation) is in excellent agreement with the experimental data (Experiment). The Rietveld refinement results including various agreement factors are listed in Table 1.

TABLE 1
Lattice parameters of Al₂Mo₆S₈

| | |
|---|---|
| Space group: R-3H | Rₑₓₚ: 2.37 |
| a (Å): 9.6356 | R_{wp}: 4.58 |
| c (Å): 9.9942 | Rₚ: 3.40 |
| Cell volume (Å³): 803.5904 | R-Bragg: 3.312 |
| Crystallite size (nm): 145.2 | GOF: 1.93 |

More importantly, the refinement result support the hypothesis that Al atoms are intercalated into two different sites in the Mo₆S₈ lattice with a theoretical formula of AL₂Mo₆S₈ at full Al intercalation (theoretical capacity of 193 mA h g⁻¹). The crystal structure of AL₂Mo₆S₈ is illustrated in FIG. 3D, showing the packing of Mo₆S₈ units and Al atoms intercalated in two different sites. The larger site (Al1) can be seen as a cubic center of a hexahedron with eight Mo₆S₈ unites as the vertices, while the smaller site (Al2) can be seen as face centered.

Crystallographic views of AL₂Mo₆S₈ from more directions are shown in FIGS. 9A-9C. Al can be more easily intercalated into the Al, sites leading to a stoichiometric formula of AL₂Mo₆S₈ (corresponding to the first discharge plateau). As for the Al₂ sites, although we can identify six available sites on the faces of the hexahedron mentioned above, in the case of Al ion with three positive charges we hypothesize the strong electrostatic force can only allow filling in two of the six sites,1²³¹ which also gives a stoichiometric formula of ALMo₆S₈ (corresponding to the second discharge plateau). Therefore the fully Al intercalated formula is AL₂Mo₆S₈, which is consistent with the refinement result. Furthermore, the stronger electrostatic interaction in Ah sites may be the reason of the incomplete Al intercalation and extraction.

In conclusion, we present in this study a new prototype rechargeable Al battery with Al metal anode, Chevrel phase Mo₆S₈ cathode, and AlCl₃-[BMIm]Cl ionic liquid based electrolyte. The Mo₆S₈ cathode shows unambiguous electrochemical activity for reversible Al intercalation and extraction and good cycle stability. The chronopotentiometric plateaus in Al—Mo₆S₈ charge-discharge curves indicate phase-transition type of electrochemical reaction, which is proposed as follows.

Discharge: Al+7[AlCl₄]⁻→4[Al₂Cl₇]⁻+3e⁻ (at Al anode)

8[Al₂Cl₇]⁻+6e⁻+Mo₆S₈→Al₂Mo₆S₈+14[AlCl₄]⁻ (at Mo₆S₈ cathode)

Charge: 4[Al₂Cl₇]⁻+3e⁻→Al+7[AlCl₄]⁻ (at Al anode)

Al₂Mo₆S₈+14[AlCl₄]⁻→8[Al₂Cl₇]⁻+6e⁻+Mo₆S₈ (at Mo₆S₈ cathode)

Although Chloride ionic liquids are shown as an example, the invention is not so limited. Other ionic liquids include, but are not limited to AlBr₃. Corresponding electrolytes may include organic salts such as 1-butylpyridinium bromide, 1-ethyl-3-methylimidazolium bromide, and 1-butyl-3-methylimidazolium bromide. Other chemical systems apart from chloride and bromide systems are also within the scope of the invention.

In addition to the electrochemical analysis, XRD investigations provide the crystallographic information of the Al intercalated Mo₆S₈. We conclude that the theoretical chemical formula of fully Al intercalated Mo₆S₈ is Al₂Mo₆S₈ with Al occupying two different sites in the Mo₆S₈ crystal lattice. The theoretical material-level specific energy of the Al—Mo₆S₈ battery is approximately 90 Wh kg⁻¹ (assuming 0.5 V nominal voltage), which makes this new rechargeable battery technology an attractive alternative for large-scale sustainable energy storage.

### Experimental Section:

Synthesis of Chevrel Phase Mo6S8: All reagents were used after purchase without further purification. Stoichiometric amounts of anhydrous copper(II) chloride (CuCl₂, 0.3442 g, 2.56 mmol, Sigma Aldrich 99.995%) and ammonium tetrathiomolybdate ((NHi)₂MoS₄, 2.000 g, 7.68 mmol; Fisher Scientific 99.99%) were dissolved in N,N-Dimethylfonnamide (DMF, 65 mL, Sigma Aldrich 99.8%) and the mixture was stirred for 30 min at room temperature. The resultant solution was then heated at 90° C. for 6 hours under continuous argon bubbling. After the reaction was completed, the solution was filtered, and tetrahydrofuran (THF, 1:5 by volume) was added immediately to the filtrate to initiate precipitation. The precipitate was collected by centrifuge, washed with THF and dried in the vacuum oven at 150° C. overnight. The dried solid agglomerate was then ground and heated in a tube furnace at 1000° C. for 7 hour under reducing environment (95 vol. % Ar and 5 vol. % H2) to yield Cu₂Mo₆S₈. The obtained Cu₂Mo₆S₈ was then added into 20 mL 6M HCl solution. Oxygen was bubbled into the solution for 8 hours to leach copper out of Cu₂Mo₆S₈ to yield Mo₆S₈. After the reaction, the obtained Mo₆S₈ was centrifuged, washed with deionized water three times and dried in vacuum oven at 50° C. overnight.

Electrochemical Measurement: CR2016 type coin cells were assembled in an argon-filled glovebox. To prevent the potential corrosion from the acidic electrolyte, titanium foil was used as lining at both electrodes inside the stainless steel coin cell casing. Al foil with 0.2 nun thickness (Alfa Aesar 99.9999%) was used as the anode. Cathode was fabricated by coating.

Mo₆S₈ slurry onto carbon paper current collector (Toray Paper, Fuel Cell Earth). The electrochemical stability of the carbon paper current collector is shown in FIGS. 10A-10B. The slurry was made by mixing 80 wt. % Mo₆S₈, 10 wt. % carbon black, and 10 wt. % polyvinylidene fluoride in N-Methyl-2-pyrrolidone solution via a mechanical mixer for 5 min in the argon-filled glovebox. A single Whitman® glass fiber filter was used as the separator in each coin cell. The electrolyte was synthesized by slowly adding anhydrous AlCl₃ (Sigma Aldrich 99.99%) into [BMIm]Cl (Sigma Aldrich 99.0%) with a molar ratio of 1.5:1 while stirring. The CV of Al deposition-dissolution, the constant current Al deposition and the electrochemical stability test of the carbon paper current collector were performed in three-electrode cells with a potentiostat (Gamry Interface 3000) using two Al wires (2.0 mm diameter, Alfa Aesar 99.9995%) as the counter and the reference electrodes, respectively. The CV scan rate for Al deposition-dissolution experiment was 100 mV s⁻¹. A constant current density of −5 mA cm⁻² was applied on Ni working electrode in electrochemical Al deposition experiment. The GCD experiments of Al—Mo₆S₈ were performed with an Arbin battery test station, and the CV analysis of Al—Mo₆S₈ was conducted on a Gamry potentiostat (Interface 1000) with a scan rate of 0.1 mV s⁻¹.

Materials Characterization: The X-ray diffraction was conducted using PANalytical EMPYREAN instrument (45 kV/40 mA) with a Cu-Ku source. The inductively coupled plasma optical emission spectometry of Al intercalated Mo₆S₈ was performed by Elemental Analysis, Inc. (Lexington, Ky.). The Rietveld refinement was performed using the TOPAS program. Scanning electron microscopy was performed with a PEI XL30-FEG (10 kV/192 (μA)

FIGS. 12A-12D shows a) SEM image and b) XRD pattern of the synthesized Mo₆S₈. c) CV curves of Al deposition-dissolution. d) SEM image and the XRD pattern (inset) of the deposited Al on Ni.

Rechargeable batteries based on aluminum (Al) anode have attracted great attention recently. Despite a few cathode materials that have been proposed, cathode materials with potentially higher energy density need to be explored. Herein, we investigate the layered TiS₂ and cubic Ti₂S₄ as intercalation-type cathodes at both room temperature and 50° C. We confirm the Al intercalation in the TiS₂ and Ti₂S₄ crystal structure using ex-situ XRD and XPS. The proposed titanium sulfide cathodes showed promising reversible capacity and a higher working potential than previously demonstrated Chevrel phase molybdenum sulfide cathode. More importantly, it further validates the generalization of transition metal sulfides as feasible cathodes for rechargeable Al batteries.

Rechargeable aluminum (Al) battery system is very intriguing due to the following reasons: First of all, aluminum has high capacity due to its trivalency. Al is the most abundant metal element in earth's crust. However, not too many investigations have been made on developing rechargeable aluminum battery in the past decades. One of the main reasons is the lack of electrolyte that can enable facile deposition and dissolution of aluminum on the anode side. To date, facile electrochemical deposition and dissolution of Al at room temperature can be only achieved in Lewis Acidic room temperature ionic liquid (RTIL) electrolytes synthesized by mixing aluminum chloride (AlCl₃) with organic salts such as 1-butylpyridinium chloride, 1-ethyl-3-methylimidazolium chloride, etc.

Our group proposed Chevrel phase Mo₆S₈ as the first conventional intercalation type cathode material. The logic of choosing transition metal sulfide instead of transition metal oxide as cathode material for aluminum ion battery is very important. Due to the strong coulombic effect, the energy barrier of multivalent ions transportation in the crystal structure is very high. Thus, a softer anionic framework is needed. Sulfide has a much lower electronegativity than oxide, which makes transition metal sulfides very promising cathode candidates for rechargeable aluminum ion battery. Herein, we report the synthesis of cubic Ti₂S₄ and layered TiS₂ and investigation on their electrochemical and structural properties as cathode materials for rechargeable aluminum ion batteries.

The reason we picked cubic Ti₂S₄ as cathode candidate for rechargeable aluminum ion battery is the similarities between it and the Chevrel Phase Mo₆S₈. The synthesis route of both the materials are very alike: first, copper based materials (Cu₂Mo₆S₈, CuTi₂S₄) can be synthesized using solid state method. Then copper is chemically leached out to produce the desired materials. More importantly, we believe the void space in the crystal structure created by leaching copper out will make it easier for the intercalation of aluminum ion. Titanium sulfide has a higher working potential than molybdenum sulfide. Titanium sulfide also has a higher electrochemical capacity than molybdenum sulfide.

As for layered TiS₂, it has the same chemical composition with cubic Ti₂S₄ while the crystal structure is totally different. It would make a very interesting comparison between their electrochemical activities towards aluminum ion. Both cubic Ti₂S₄ and layered TiS₂ were synthesized via solid state reaction by heating of stoichiometric mixture of elements in vacuum sealed quartz tube. Then we generated the nano sized particles by ball milling. The detailed synthesis information is in the method session.

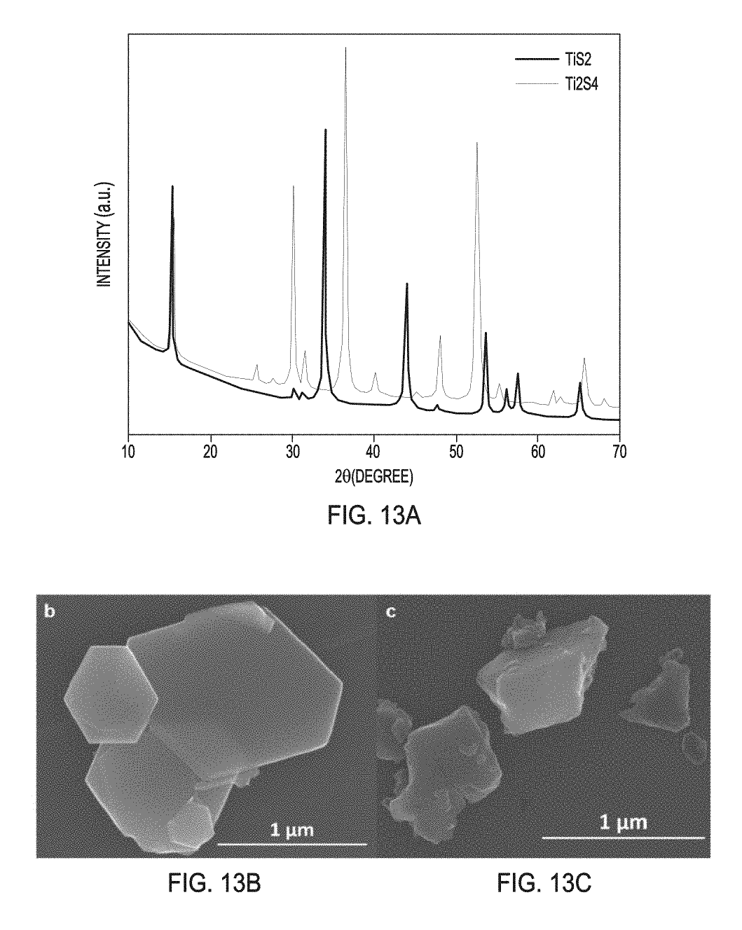

FIG. 13A shows the x-ray diffraction pattern of as synthesized nano Ti₂S₄ and TiS₂ which are in very good agreement with standard. Moreover, we can easily notice the peak widening after the ball milling treatment of the particle that indicates the decrease of the particle size. FIG. 13B shows the SEM image of layered TiS₂ with the typical layered structure featuring of a pellet shape. The particle size is mostly around 1 μm while the thickness of the pellets is much smaller. FIG. 13C depicts the typical particle morphology of ball milled cubic Ti₂S₄. The particle size is mostly sub 1 μm.

All the electrochemical analysis of the cathode materials is undertaken in the 2016 type coin cells. Pure aluminum metal foil serves as the anode. Titanium sulfide pasted on the carbon paper current collector serves as cathode. The AlCl₃/EMImCl ionic liquid with molar ratio of 1.5:1 is the electrolyte. Titanium foil lining was applied at both ends of the battery case to prevent the corrosion effect on stainless steel from the ionic liquid electrolyte containing chloride ions. Based on the assumption that the energy barrier of aluminum ion transportation in the crystal structure will be very high, so besides analyzing the electrochemical properties at room temperature, we also operated all the tests at elevated temperature of 50° C. in order to accelerate the reaction transportation and kinetics.

FIGS. 14A and 14B are the second cycle of cyclic voltammetry (CV) of layered TiS₂ and cubic Ti₂S₄ at room temperature and 50° C. respectively. From the 14a we can see that there are clearly two reduction peaks at around 0.9V and 0.3V for layered TiS₂. We can notice that the reduction peak at higher potential is more pronounced at elevated temperature than itself at room temperature. As for the oxidation peaks, the situation is more complicated. At room temperature, two corresponding oxidation peaks can be easily observed locating at about 1.1V and 0.7V accordingly. While at 50° C., the oxidation peaks shifted to the left making the redox peak separation smaller, indicating a better kinetics. In addition, we started to observe corrosion effect starting around 1.2V. We believe the later part of the oxidation peak is overlapping with the corrosion reaction peak before 1.4V, which thereafter the corrosion reaction takes complete charge.

As for the CV of cubic Ti₂S₄ in FIG. 14B, we can also observe mainly two redox pairs similarly to layered Ti₂. At room temperature, the first reduction is more like a slope at 1.0V. The second reduction peak is much more pronounced at around 0.35V. The corresponding oxidation peaks are very distinctive at around 1.1V and 0.65V. While at 50° C., two reduction peaks can be easily observed at 1.0V and 0.5V. And the corresponding oxidation peaks are located at 1.2V and 0.6V respectively. We can see that the peak separation at higher temperature is smaller due to the better kinetics. Similarly, corrosion effect is also seen when approach the end of the charging process.

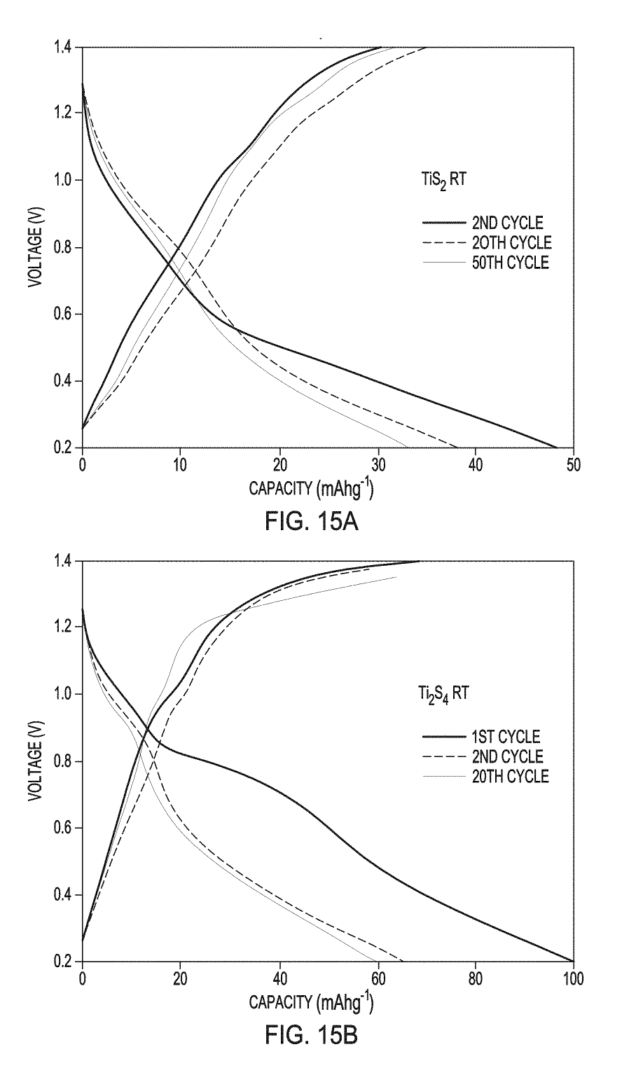

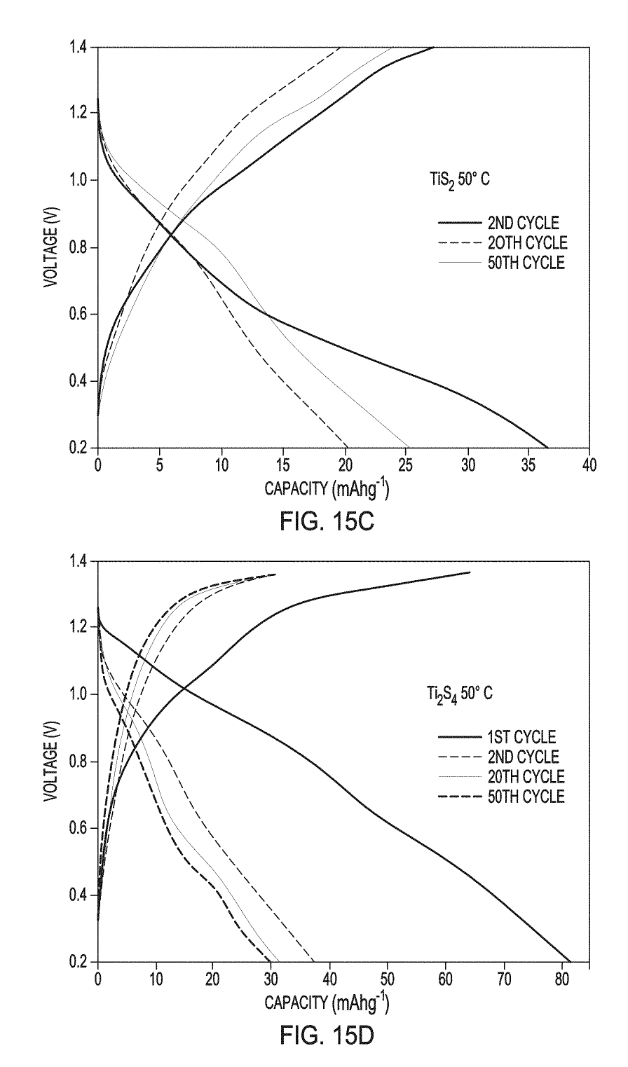

Galvanostatic charge discharge tests were also undertaken at both room temperature and 50° C. for layered TiS₂ and cubic Ti₂S₄ as can be depicted in FIGS. 15A-15D. A current density of 5 mAg⁻¹ was used in the tests. The charge discharge curves at room temperature and 50° C. are basically the same, Unsurprisingly, the capacity is higher and the charge discharge plateaus are more distinctive at 50° C. since the charge transfer kinetics is better due to the higher temperature. Therefore, only the charge discharge performance at 50° C. is going to be analyzed here.

FIG. 15B shows the 1^{st}, 2^{nd} and 20^{th} galvanostatic charge discharge curves of layered TiS₂ at 50° C. In the first cycle, we can see that there is a discharge plateau at 0.75V, and then followed by a slope at around 0.4V, which correspond the two reduction peaks in the CV. A capacity of 100 mAhg⁻¹ can he achieved in the first discharge. The first charge is also comprised with two stages which is also in good agreement with the CV. It is worth noting that the first charge is only 75 mAhg⁻¹ indicating there is a big reversibility. Starting from the second cycle, two discharge stages can still be observed in the discharge process. However, the first discharge plateau voltage increased to around 0.9V instead of 0.75V in the first cycle. The second discharge process is still a slope at around 0.4V.

We hypothesize that the Al intercalation process in the first cycle expands the lattice parameter of TiS₂ that can enable the subsequent intercalation at a higher potential. Moreover, the capacity of the second discharge is only about 65 mAhg⁻¹ which is only two thirds of the discharge capacity in the first cycle. But the discharge capacity stabilized from second cycle and slowly decreased to around 60 mAhg⁻¹ in the 20^{th} cycle. FIG. 15D shows the 1^{st}, 2^{nd}, 20^{th} and 50^{th} galvanostatic charge discharge curves of cubic Ti₂S₄ at 50° C. From the 1^{st} discharge curve, two slope-shape discharge processes can be observed at about 0.95V and 0.45V, which are in very good agreement with the two broad CV peaks in FIG. 14B. The first discharge capacity of Ti₂S₄ at 50° C. is often around 80 mAhg⁻¹. As for the first charge, two corresponding charging plateaus can be easily identified while the first charging capacity is only about 65 mAhg⁻¹. However, the following second discharge could only achieve a capacity of about 40 mAhg⁻¹, half the capacity in the first cycle. Then the discharge capacity quickly stabilized and a capacity of 30 mAhg⁻¹ can be achieved after 50 cycles.

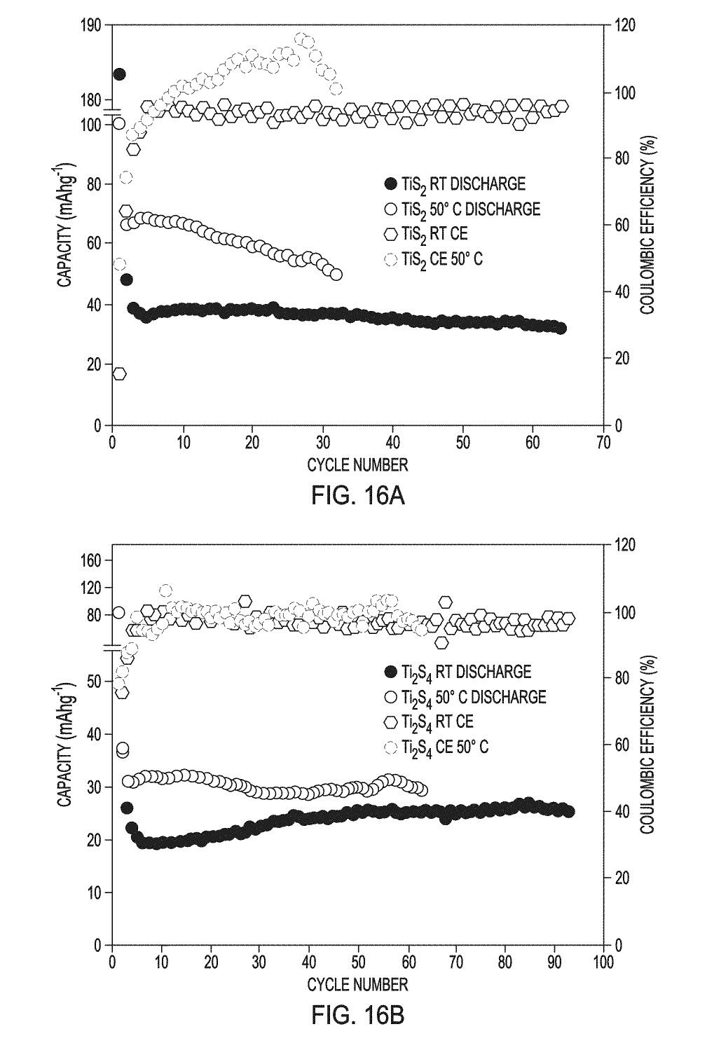

Cycle stability performance of both TiS₂ and Ti₂S₄ is given in FIGS. 16A-16B. FIG. 16A shows the cycle stability of layered TiS₂ at room temperature and 50° C. with a current density of 5 mAg⁻¹. At room temperature, the first discharge capacity of TiS₂ is as high as 185 mAg⁻¹. However, due to the large irreversibility, the capacity after stabilization dropped to about 35 mAhg⁻¹. While at 50° C., the irreversibility between the first and second cycle becomes smaller, with a discharge capacity of 100 mAhg⁻¹ in the first cycle and 65 mAhg⁻¹ in the second cycle. However, the stability is worse at 50° C. The discharge capacity dropped from 65 mAhg⁻¹ in the second cycle to about 55 mAhg⁻¹ in the 30^{th} cycle. Also it is worth noting that the coulombic efficiency at 50° C. fluctuated fiercely while being higher than 100%.

We believe it is the corrosion effect that caused the deterioration of the cycle stability and coulombic efficiency of TiS₂ at 50° C. FIG. 16B shows the cycle performance of cubic Ti₂S₄. Similarly, the Ti₂S₄ can also achieve a very high discharge capacity of 170 mAhg⁻¹ in the first discharge at room temperature. However, the discharge capacity after stabilization is only around 25 mAhg−1. While at 50° C., cubic Ti₂S₄ can achieve a first discharge capacity of 80 mAhg⁻¹ and the capacity after stabilization is about 30 mAhg⁻¹.

By comparing the cycling performance of layered TiS₂ and cubic Ti₂S₄, we can speculate that TiS₂ will give higher electrochemical capacity than Ti₂S₄. On the other hand, cubic Ti₂S₄ has a better cycle stability then layered TiS₂. The reason is that spinel structure is more stable than layered structure especially in a harsh environment of acidic ionic liquid and high temperature.

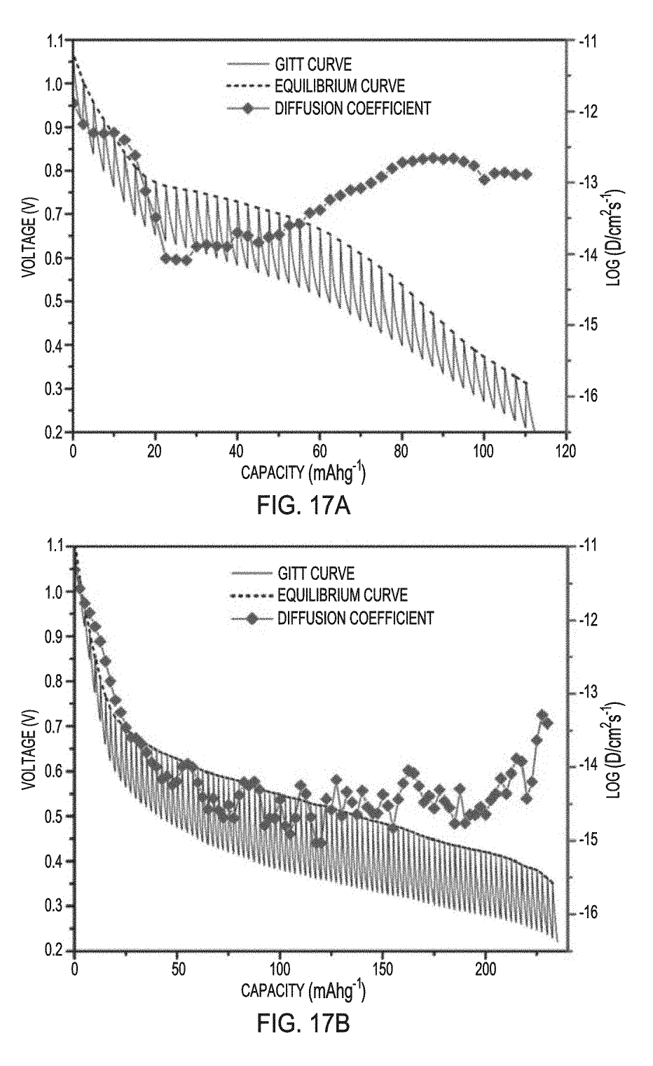

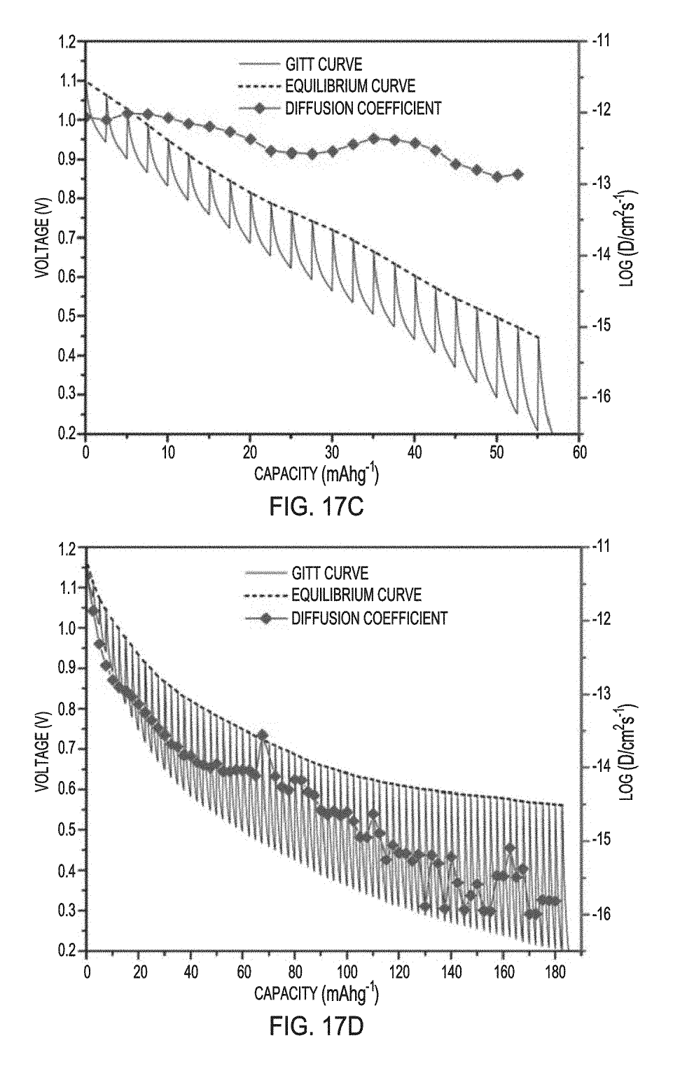

Although aluminum ion has an even smaller ionic radius than lithium ion, the diffusion energy barrier of aluminum ion in the cathode material particle is significant higher mainly due to the 3 positive charges. As a result, it is very meaningful to know the diffusion coefficient of aluminum ion in layered TiS₂ and Ti₂S₄ in order to shed some light on the aforementioned electrochemical behaviors. Galvanostatic intermittent titration techniques (GITT) along with equilibrium potential and calculated diffusion coefficients are presented in FIGS. 17A-17D.

All the GITT experiments were conducted in such a way: imposing intermittent pulse with a current density of 10 mAg⁻¹ for 15 minutes followed by a rest time of 2 hours. FIGS. 17A and 17B show the GITT of layered TiS₂ at room temperature and 50° C. We believe that the GITT curve of TiS₂ started with a solid state solution process followed by a charge transfer stage indicating by the equilibrium potential plateau, then followed by another solid state diffusion stage. This hypothesis is also supported by the changing trend of the diffusion coefficient.

In FIG. 17A, the diffusion coefficient during the charge transfer stage at around 0.7V is in the range of 10⁻¹⁴ cm² s⁻¹, which is more than 1 order of magnitude lower than that in the solid state diffusion stage. As for the GITT curve of TiS₂ at 50° C., it is very obvious that the capacity is doubled compared to the capacity of room temperature GITT. Moreover, the change transfer plateau is much longer. We can see that the diffusion coefficient during the charge transfer stage at 50° C. is in the range of 10⁻¹⁴-10⁻¹⁵ cm² s⁻¹, which is even lower than that at room temperature.

We speculate that the higher temperature can enable aluminum ion transport much deeper to the core of the particle where the diffusion energy barrier is higher than that at the surface of the particle. FIGS. 17C and 17D show the GITT of cubic Ti₂S₄ at RT and 50° C. respectively. With similar analysis, we can get a conclusion that the aluminum diffusion happened mostly superficially for cubic Ti₂S₄ at room temperature because of the low capacity and high diffusion coefficient. While at 50° C. as can be seen in FIG. 17D, the diffusion coefficient decreased to 10⁻¹⁵-10⁻¹⁶ cm² s⁻¹ as the diffusion approach deeper into the core of the Ti₂S₄ particle.

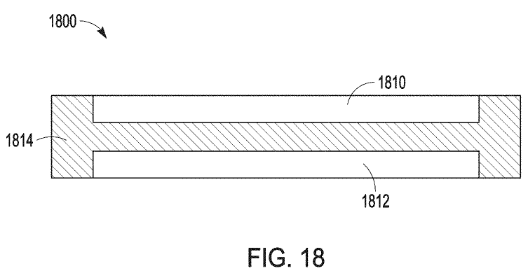

FIG. 18 shows an example of a battery 1800 according to an embodiment of the invention. The battery 1800 is shown including an anode 1810 and a cathode 1812. An electrolyte 1814 is shown between the anode 1810 and the cathode 1812. In one example, the battery 1800 utilizes an ionic fluid electrolyte containing aluminum as described in examples above. In one example, the anode 1810 is formed from aluminum as described in examples above. In one example, the cathode 1812 is formed from a metal sulfide as described in examples above. In one example, although the invention is not so limited, the battery 1800 is formed to comply with a 2032 coin type form factor. In one example, although the invention is not so limited, the battery 1800 is formed to comply with a 2016 coin type form factor.

To better illustrate the method and apparatuses disclosed herein, a non-limiting list of embodiments is provided here.

Example 1 includes a battery. The battery includes a first electrode, including titanium sulfide, a second electrode, and an ionic liquid electrolyte in contact with both the first electrode and the second electrode, wherein the ionic liquid electrolyte includes aluminum.

Example 2 includes the battery of example 1, wherein the ionic liquid electrolyte includes an organic salt.

Example 3 includes the battery of any one of examples 1-2, wherein the ionic liquid electrolyte includes AlCl₃.

Example 4 includes the battery of any one of examples 1-3, wherein the ionic liquid electrolyte includes 1-butylpyridinium chloride.

Example 5 includes the battery of any one of examples 1-4, wherein the ionic liquid electrolyte includes 1-ethyl-3-methylimidazolium chloride.

Example 6 includes the battery of any one of examples 1-5, wherein the ionic liquid electrolyte includes 1-butyl-3-methylimidazolium chloride.

Example 7 includes the battery of any one of examples 1-6, wherein the first electrode includes Ti₂S_{4.}

Example 8 includes the battery of any one of examples 1-7, wherein the second electrode includes aluminum.

Example 9 includes the battery of any one of examples 1-8, wherein a molar ratio of AlCl₃ to organic salt is greater than 1.

Example 10 includes the battery of example 9, wherein the molar ratio of AlCl₃ to organic salt is equal to 1.5:1.

These and other examples and features of the present electronic device, and related methods will be set forth in part in the above detailed description. This overview is intended to provide non-limiting examples of the present subject matter—it is not intended to provide an exclusive or exhaustive explanation.

While a number of advantages of embodiments described herein are listed above, the list is not exhaustive. Other advantages of embodiments described above will be apparent to one of ordinary skill in the art, having read the present disclosure. Although specific embodiments have been illustrated and described herein, it will be appreciated by those of ordinary skill in the art that any arrangement which is calculated to achieve the same purpose may be substituted for the specific embodiment shown. This application is intended to cover any adaptations or variations of the present invention. It is to be understood that the above description is intended to be illustrative, and not restrictive. Combinations of the above embodiments, and other embodiments will be apparent to those of skill in the art upon reviewing the above description. The scope of the invention includes any other applications in which the above structures and fabrication methods are used. The scope of the invention should be determined with reference to the appended claims, along with the full scope of equivalents to which such claims are entitled.

What is claimed is:

1. A battery, comprising:
a first electrode, including titanium sulfide;
a second electrode; and
an ionic liquid electrolyte in contact with both the first electrode and the second electrode, wherein the ionic liquid electrolyte includes aluminum.

2. The battery of claim 1, wherein the ionic liquid electrolyte includes an organic salt.

3. The battery of claim 2, wherein the ionic liquid electrolyte includes AlCl₃.

4. The battery of claim 1, wherein the ionic liquid electrolyte includes 1-butylpyridinium chloride.

5. The battery of claim 1, wherein the ionic liquid electrolyte includes 1-ethyl-3-methylimidazolium chloride.

6. The battery of claim 1, wherein the ionic liquid electrolyte includes 1-butyl-3-methylimidazolium chloride.

7. The battery of claim 1, wherein the first electrode includes Ti₂S_{4.}

8. The battery of claim 1, wherein the second electrode includes aluminum.

9. The battery of claim 3, wherein a molar ratio of AlCl₃ to organic salt is greater than 1.

10. The battery of claim 9, wherein the molar ratio of AlCl₃ to organic salt is equal to 1.5:1.
